(19) United States
(12) Patent Application Publication
(10) Pub. No.: US 2026/0213910 A1
(43) Pub. Date: Jul. 23, 2026

(54) REFERENCE SIGNAL TIMING OFFSET REPORTING FOR MULTIPLE TRANSMISSION RECEPTION POINT COHERENT JOINT TRANSMISSION CHANNEL STATE INFORMATION FEEDBACK

(71) Applicant: QUALCOMM Incorporated, San Diego, CA (US)

(72) Inventors: Jae Ho RYU, San Diego, CA (US); Jing DAI, Beijing (CN); Lei XIAO, San Jose, CA (US); Faris RASSAM, El Cajon, CA (US)

(21) Appl. No.: 19/140,100

(22) PCT Filed: Feb. 7, 2023
(86) PCT No.: PCT/CN2023/074855

§ 371 Date: Jun. 17, 2025

(51) Int. Cl. H04L 5/00

(52) U.S. Cl. CPC H04L 5/0094; H04L 5/0048

(57) ABSTRACT

Various aspects of the present disclosure generally relate to wireless communication. In some aspects, a user equipment (UE) may receive configuration information associated with an inter-transmission configuration indication (TCI) downlink timing offset reporting operation. The UE may receive a first reference signal associated with a first TCI state. The UE may receive a second reference signal associated with a second TCI state. The UE may transmit, based on the configuration information, inter-TCI downlink timing offset information indicating a downlink timing offset associated with at least one of the first TCI state or the second TCI state. Numerous other aspects are described.

### FIELD OF THE DISCLOSURE

Aspects of the present disclosure generally relate to wireless communication and to techniques and apparatuses for reference signal timing offset reporting for multiple transmission reception point coherent joint transmission channel state information feedback.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of multiple transmission reception point (mTRP) communication, in accordance with the present disclosure.

FIG. 5 is a diagram illustrating an example associated with reference signal timing offset reporting for mTRP coherent joint transmission (CJT) channel state information (CSI) feedback, in accordance with the present disclosure.

FIG. 6 is a diagram illustrating an example associated with reference signal timing offset reporting for mTRP CJT CSI feedback, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram illustrating an example process performed, for example, by a UE, in accordance with the present disclosure.

FIG. 10 is a diagram illustrating an example process performed, for example, by a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### SUMMARY

Some aspects described herein relate to a user equipment (UE) for wireless communication. The UE may include a memory and one or more processors coupled to the memory. The one or more processors may be configured to receive configuration information associated with an inter-transmission configuration indication (inter-TCI) downlink timing offset reporting operation. The one or more processors may be configured to receive a first reference signal associated with a first TCI state. The one or more processors may be configured to receive a second reference signal associated with a second TCI state. The one or more processors may be configured to transmit, based on the configuration information, inter-TCI downlink timing offset information indicating a downlink timing offset associated with at least one of the first TCI state or the second TCI state.

Some aspects described herein relate to a network node for wireless communication. The network node may include a memory and one or more processors coupled to the memory. The one or more processors may be configured to transmit configuration information associated with an inter-TCI downlink timing offset reporting operation. The one or more processors may be configured to transmit a first reference signal associated with a first TCI state. The one or more processors may be configured to transmit a second reference signal associated with a second TCI state. The one or more processors may be configured to receive, based on the configuration information, inter-TCI downlink timing offset information indicating a downlink timing offset associated with at least one of the first TCI state or the second TCI state.

Some aspects described herein relate to a UE for wireless communication. The UE may include a memory and one or more processors coupled to the memory. The one or more processors may be configured to receive configuration information associated with multiple transmission reception point (mTRP) coherent joint transmission (CJT) channel state information (CSI) reporting operation, the configuration information indicating an inter-CSI-RS for CSI measurement (inter-CMR) downlink timing offset reporting operation. The one or more processors may be configured to receive a first CMR associated with a first transmission reception point (TRP). The one or more processors may be configured to receive a second CMR associated with a second TRP. The one or more processors may be configured to transmit, based on the configuration information, CSI feedback information that includes inter-CMR downlink timing offset information indicating a timing offset associated with at least one of the first CMR or the second CMR.

Some aspects described herein relate to a network node for wireless communication. The network node may include a memory and one or more processors coupled to the memory. The one or more processors may be configured to transmit configuration information associated with an mTRP CJT CSI reporting operations, the configuration information indicating an inter-CMR downlink timing offset reporting operation. The one or more processors may be configured to transmit a first CMR associated with a first TRP. The one or more processors may be configured to transmit a second CMR associated with a second TRP. The one or more processors may be configured to receive, based on the configuration information, CSI feedback information that includes inter-CMR downlink timing offset information indicating a timing offset associated with at least one of the first CMR or the second CMR.

Some aspects described herein relate to a method of wireless communication performed by a UE. The method may include receiving configuration information associated with an inter-TCI downlink timing offset reporting operation. The method may include receiving a first reference signal associated with a first TCI state. The method may include receiving a second reference signal associated with a second TCI state. The method may include transmitting, based on the configuration information, inter-TCI downlink timing offset information indicating a downlink timing offset associated with at least one of the first TCI state or the second TCI state.

Some aspects described herein relate to a method of wireless communication performed by a network node. The method may include transmitting configuration information associated with an inter-TCI downlink timing offset reporting operation. The method may include transmitting a first reference signal associated with a first TCI state. The method may include transmitting a second reference signal associated with a second TCI state. The method may include receiving, based on the configuration information, inter-TCI downlink timing offset information indicating a downlink timing offset associated with at least one of the first TCI state or the second TCI state.

Some aspects described herein relate to a method of wireless communication performed by a UE. The method may include receiving configuration information associated with an mTRP CJT CSI reporting operation, the configuration information indicating an inter-CMR downlink timing offset reporting operation. The method may include receiving a first CMR associated with a first TRP. The method may include receiving a second CMR associated with a second TRP. The method may include transmitting, based on the configuration information, CSI feedback information that includes inter-CMR downlink timing offset information indicating a timing offset associated with at least one of the first CMR or the second CMR.

Some aspects described herein relate to a method of wireless communication performed by a network node. The method may include transmitting configuration information associated with an mTRP CJT CSI reporting operations, the configuration information indicating an inter-CMR downlink timing offset reporting operation. The method may include transmitting a first CMR associated with a first TRP. The method may include transmitting a second CMR associated with a second TRP. The method may include receiving, based on the configuration information, CSI feedback information that includes inter-CMR downlink timing offset information indicating a timing offset associated with at least one of the first CMR or the second CMR.

Some aspects described herein relate to a non-transitory computer-readable medium that stores a set of instructions for wireless communication by a UE. The set of instructions, when executed by one or more processors of the UE, may cause the UE to receive configuration information associated with an inter-TCI downlink timing offset reporting operation. The set of instructions, when executed by one or more processors of the UE, may cause the UE to receive a first reference signal associated with a first TCI state. The set of instructions, when executed by one or more processors of the UE, may cause the UE to receive a second reference signal associated with a second TCI state. The set of instructions, when executed by one or more processors of the UE, may cause the UE to transmit, based on the configuration information, inter-TCI downlink timing offset information indicating a downlink timing offset associated with at least one of the first TCI state or the second TCI state.

Some aspects described herein relate to a non-transitory computer-readable medium that stores a set of instructions for wireless communication by a network node. The set of instructions, when executed by one or more processors of the network node, may cause the network node to transmit configuration information associated with an inter-TCI downlink timing offset reporting operation. The set of instructions, when executed by one or more processors of the network node, may cause the network node to transmit a first reference signal associated with a first TCI state. The set of instructions, when executed by one or more processors of the network node, may cause the network node to transmit a second reference signal associated with a second TCI state. The set of instructions, when executed by one or more processors of the network node, may cause the network node to receive, based on the configuration information, inter-TCI downlink timing offset information indicating a downlink timing offset associated with at least one of the first TCI state or the second TCI state.

Some aspects described herein relate to a non-transitory computer-readable medium that stores a set of instructions for wireless communication by a UE. The set of instructions, when executed by one or more processors of the UE, may cause the UE to receive configuration information associated with an mTRP CJT CSI reporting operation. The configuration information may indicate an inter-CMR downlink timing offset reporting operation. The set of instructions, when executed by one or more processors of the UE, may cause the UE to receive a first CMR associated with a first TRP and a second CMR associated with a second TRP. The set of instructions, when executed by one or more processors of the UE, may cause the UE to transmit, based on the configuration information, CSI feedback information that includes inter-CMR downlink timing offset information indicating a timing offset associated with at least one of the first CMR or the second CMR.

Some aspects described herein relate to a non-transitory computer-readable medium that stores a set of instructions for wireless communication by a network node. The set of instructions, when executed by one or more processors of the network node, may cause the network node to transmit configuration information associated with an mTRP CJT CSI reporting operations, the configuration information indicating an inter-CMR downlink timing offset reporting operation. The set of instructions, when executed by one or more processors of the network node, may cause the network node to transmit a first CMR associated with a first TRP. The set of instructions, when executed by one or more processors of the network node, may cause the network node to transmit a second CMR associated with a second TRP. The set of instructions, when executed by one or more processors of the network node, may cause the network node to receive, based on the configuration information, CSI feedback information that includes inter-CMR downlink timing offset information indicating a timing offset associated with at least one of the first CMR or the second CMR.

Some aspects described herein relate to an apparatus for wireless communication. The apparatus may include means for receiving configuration information associated with an inter-TCI downlink timing offset reporting operation. The apparatus may include means for receiving a first reference signal associated with a first TCI state. The apparatus may include means for receiving a second reference signal associated with a second TCI state. The apparatus may include means for transmitting, based on the configuration information, inter-TCI downlink timing offset information indicating a downlink timing offset associated with at least one of the first TCI state or the second TCI state.

Some aspects described herein relate to an apparatus for wireless communication. The apparatus may include means for transmitting configuration information associated with an inter-TCI downlink timing offset reporting operation. The apparatus may include means for transmitting a first reference signal associated with a first TCI state. The apparatus may include means for transmitting a second reference signal associated with a second TCI state. The apparatus may include means for receiving, based on the configuration information, inter-TCI downlink timing offset information indicating a downlink timing offset associated with at least one of the first TCI state or the second TCI state.

Some aspects described herein relate to an apparatus for wireless communication. The apparatus may include means for receiving configuration information associated with an mTRP CJT CSI reporting operation, the configuration information indicating an inter-CMR downlink timing offset reporting operation. The apparatus may include means for receiving a first CMR associated with a first TRP. The apparatus may include means for receiving a second CMR associated with a second TRP. The apparatus may include means for transmitting, based on the configuration information, CSI feedback information that includes inter-CMR downlink timing offset information indicating a timing offset associated with at least one of the first CMR or the second CMR.

Some aspects described herein relate to an apparatus for wireless communication. The apparatus may include means for transmitting configuration information associated with an mTRP CJT CSI reporting operations, the configuration information indicating an inter-CMR downlink timing offset reporting operation. The apparatus may include means for transmitting a first CMR associated with a first TRP. The apparatus may include means for transmitting a second CMR associated with a second TRP. The apparatus may include means for receiving, based on the configuration information, CSI feedback information that includes inter-CMR downlink timing offset information indicating a timing offset associated with at least one of the first CMR or the second CMR.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

In some cases, due to differences in the propagation paths of signals received from a first transmission reception point (TRP) and a second TRP, the downlink timing of the signals may be mis-aligned. For example, downlink timing misalignment may result from inter-TRP time synchronization error and/or propagation delay differences between a user equipment (UE) and the two TRPs. In some cases, downlink timing differences among TRPs may vary over time due to independent clock drift in the first TRP and the second TRB and/or movement of the UE, which may lead to time-varying propagation delay differences between the UE and the two TRPs. Downlink timing misalignment may result in inaccurate channel state information (CSI) reporting, particularly in the case of multi-TRP (mTRP) coherent joint transmission (CJT) CSI reporting.

Some aspects of the techniques and apparatuses described herein may facilitate reference signal timing offset reporting for mTRP CJT CSI feedback. For example, in some aspects, a network node may configure a UE to provide inter-TCI downlink timing offset information associated with reference signals. The reference signals may include synchronization signal blocks (SSBs) and/or tracking reference signals (TRSs), and the inter-TCI downlink timing offset information may be used to facilitate compensating timing associated with subsequent channel state information reference signals (CSI-RSs) and/or other communications. For example, based on reported inter-TCI downlink timing offset synchronization information, the network node may transmit CSI-RSs based on an inter-TCI downlink timing offset compensation. In some other aspects, the network node may configure the UE to report inter-CSI-RS for CSI measurement (inter-CMR) downlink timing offset reporting information. For example, the network node may transmit CMRs and the UE may report inter-CMR downlink timing offset information as part of a CSI report. Based on the inter-CMR downlink timing offset information, the network node may transmit, via a physical downlink shared channel (PDSCH) and/or a physical downlink control channel (PDCCH), a communication based on an inter-CMR downlink timing offset compensation. In this way, some aspects may facilitate compensating for misalignment between downlink timing associated with multiple TRPs, thus facilitating more efficient quantization of CSI and/or more reliable communications, and thereby positively impacting device and/or network performance.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

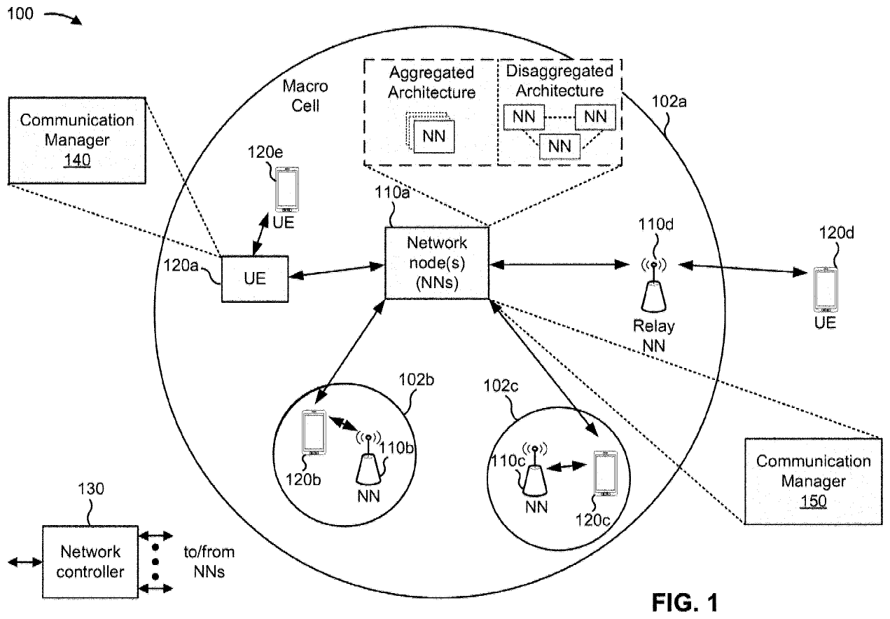

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive configuration information associated with an inter-transmission configuration indication (TCI) downlink timing offset reporting operation; receive a first reference signal associated with a first TCI state; receive a second reference signal associated with a second TCI state; and transmit, based on the configuration information, inter-TCI downlink timing offset information indicating a downlink timing offset associated with at least one of the first TCI state or the second TCI state.

In some aspects, the communication manager 140 may receive configuration information associated with a multiple transmission reception point (mTRP) coherent joint transmission (CJT) channel state information (CSI) reporting operation, the configuration information indicating an inter-CSI-RS for CSI measurement (inter-CMR) downlink timing offset reporting operation; receive a first CMR associated with a first transmission reception point (TRP); receive a second CMR associated with a second TRP; and transmit, based on the configuration information, CSI feedback information that includes inter-CMR downlink timing offset information indicating a timing offset associated with at least one of the first CMR or the second CMR. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit configuration information associated with an inter-TCI downlink timing offset reporting operation; transmit a first reference signal associated with a first TCI state; transmit a second reference signal associated with a second TCI state; and receive, based on the configuration information, inter-TCI downlink timing offset information indicating a downlink timing offset associated with at least one of the first TCI state or the second TCI state.

In some aspects, the communication manager 150 may transmit configuration information associated with an mTRP CJT CSI reporting operation, the configuration information indicating an inter-CMR downlink timing offset reporting operation; transmit a first CMR associated with a TRP; transmit a second CMR associated with a second TRP; and receive, based on the configuration information, CSI feedback information that includes inter-CMR downlink timing offset information indicating a timing offset associated with at least one of the first CMR or the second CMR. Additionally, or alternatively, the communication manager 150 may perform one or more other operations described herein.

As indicated above, FIG. 1 is provided as an example. Other examples may differ from what is described with regard to FIG. 1.

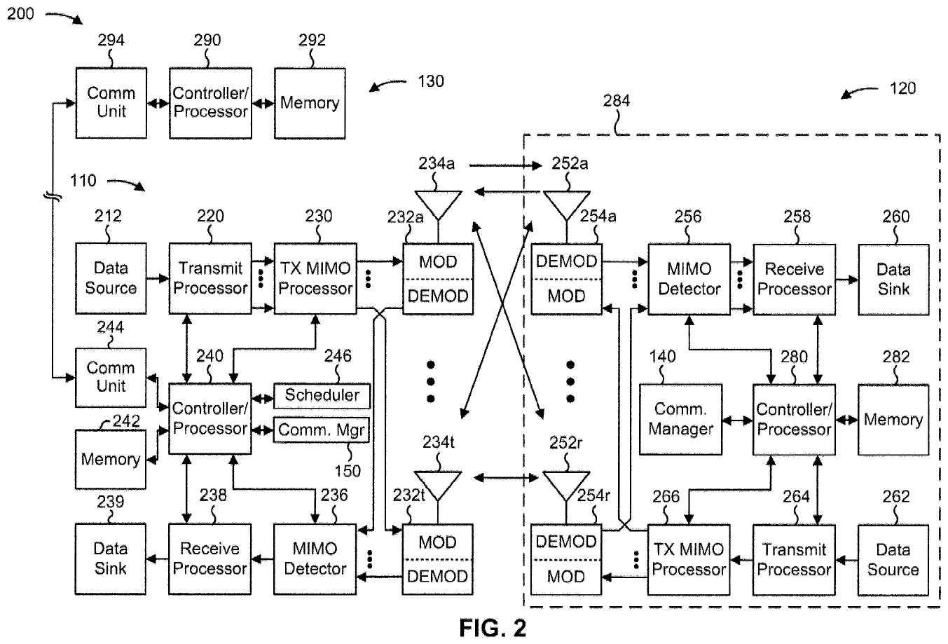

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

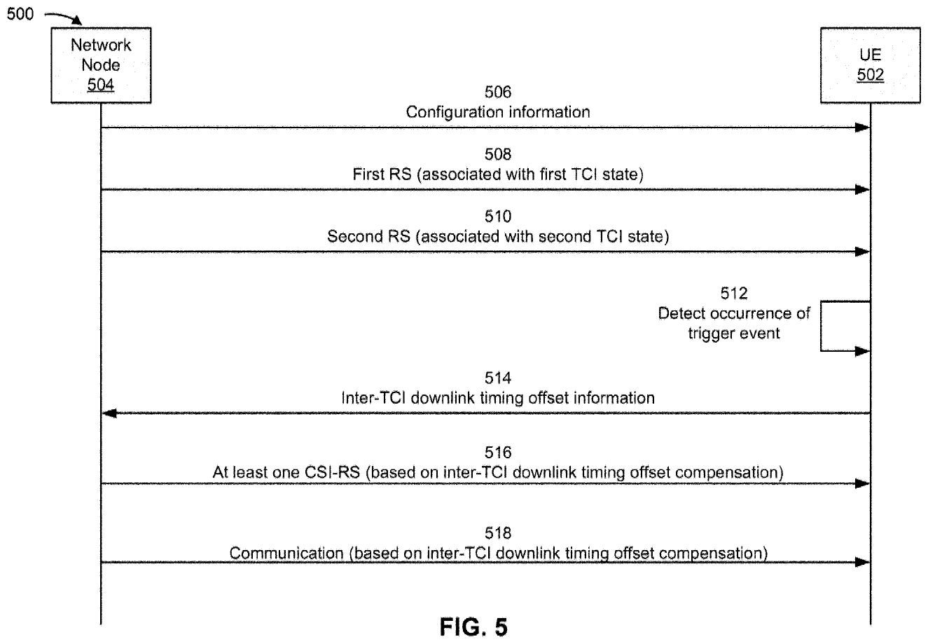

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

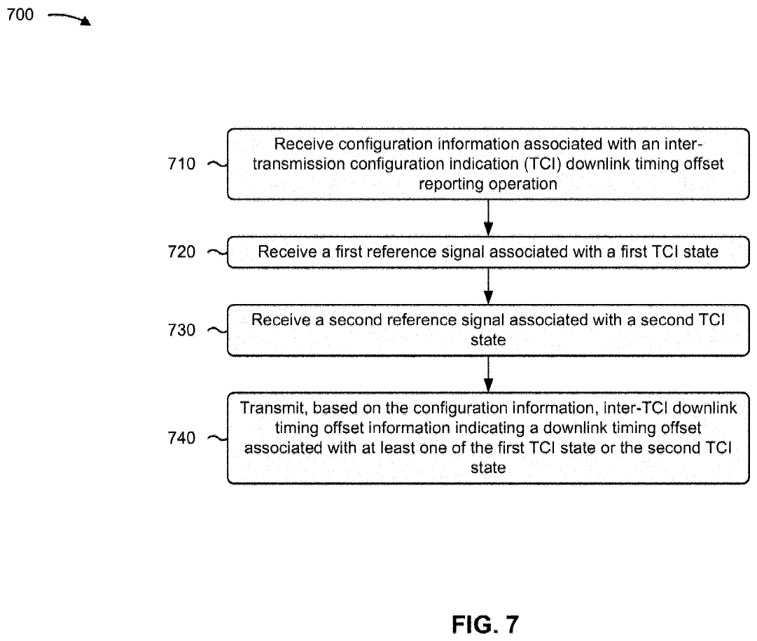

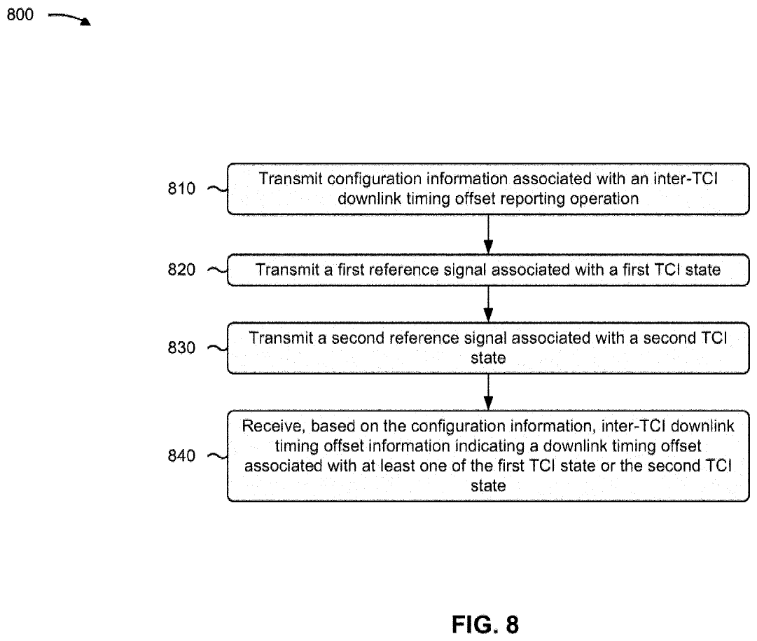

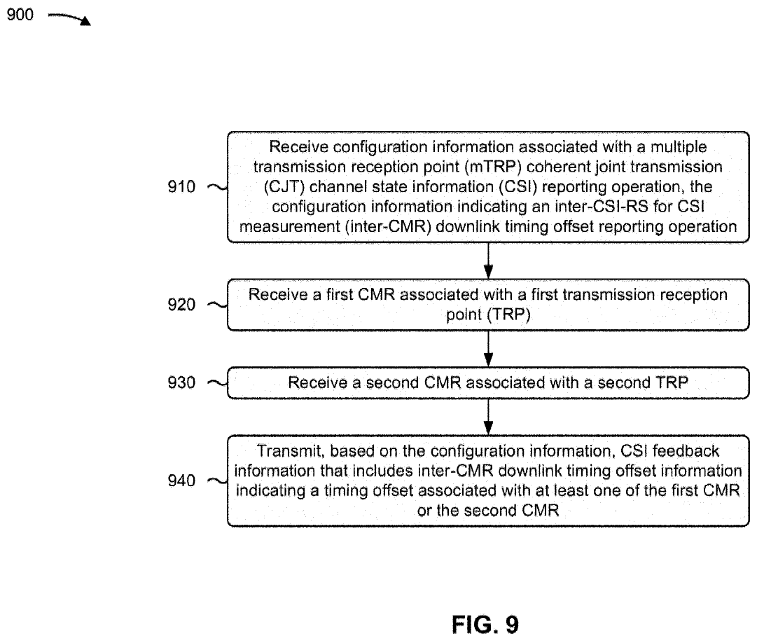

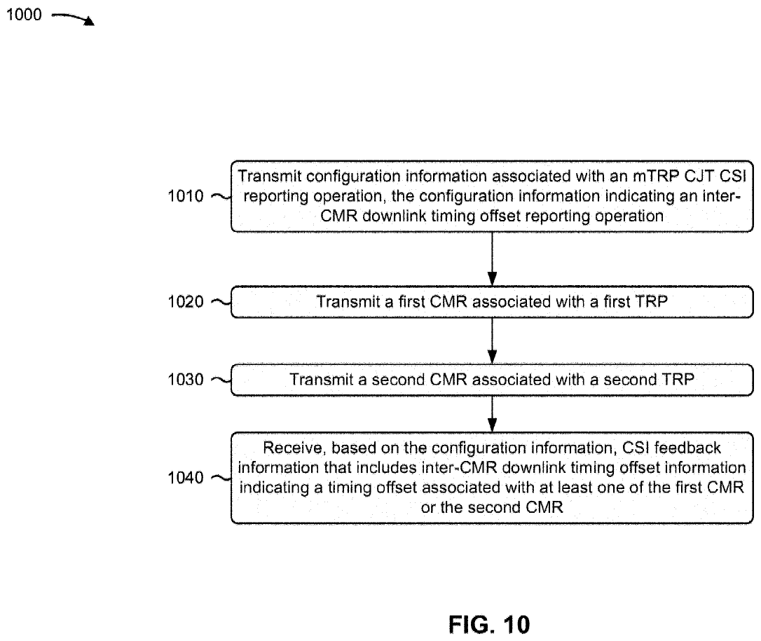

The controller/processor 240 of the network node 110, the controller/processor 280 of the UE 120, and/or any other component(s) of FIG. 2 may perform one or more techniques associated with reference signal timing offset reporting for mTRP CJT CSI feedback, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving configuration information associated with an inter-TCI downlink timing offset reporting operation; means for receiving a first reference signal associated with a first TCI state; means for receiving a second reference signal associated with a second TCI state; and/or means for transmitting, based on the configuration information, inter-TCI downlink timing offset information indicating a downlink timing offset associated with at least one of the first TCI state or the second TCI state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., the UE 120) includes means for receiving configuration information associated with an mTRP CJT CSI reporting operation, the configuration information indicating an inter-CMR downlink timing offset reporting operation; means for receiving a first CMR associated with a first TRP; means for receiving a second CMR associated with a second TRP; and/or means for transmitting, based on the configuration information, CSI feedback information that includes inter-CMR downlink timing offset information indicating a timing offset associated with at least one of the first CMR or the second CMR. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting configuration information associated with an inter-TCI downlink timing offset reporting operation; means for transmitting a first reference signal associated with a first TCI state; means for transmitting a second reference signal associated with a second TCI state; and/or means for receiving, based on the configuration information, inter-TCI downlink timing offset information indicating a downlink timing offset associated with at least one of the first TCI state or the second TCI state. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network node (e.g., the network node 110) includes means for transmitting configuration information associated with an mTRP CJT CSI reporting operation, the configuration information indicating an inter-CMR downlink timing offset reporting operation; means for transmitting a first CMR associated with a first TRP; means for transmitting a second CMR associated with a second TRP; and/or means for receiving, based on the configuration information, CSI feedback information that includes inter-CMR downlink timing offset information indicating a timing offset associated with at least one of the first CMR or the second CMR. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

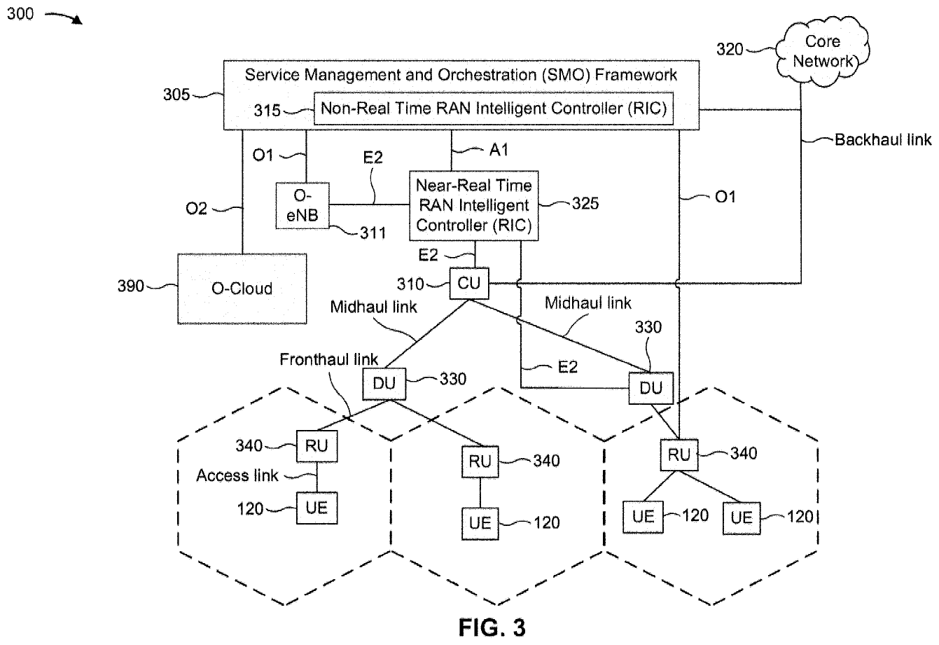

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A network node (e.g., network node 110) can transmit many beams to a UE (e.g., UE 120). “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal. For example, the network node can generate the beams using an antenna panel that generates beams at a spatial and/or phase displacement from each other. The network node and the UE can select a set of beams that are to be used for communication between the network node and the UE. For example, the set of beams transmitted from the network node to the UE can be referred to herein as a communication link, a downlink, and/or the like. The communication link between the network node and the UE can propagate in a medium and/or through various geometric paths, which are collectively referred to herein as a channel between the network node and the UE.

In some aspects, the UE can select a set of beams for communication with the network node. For example, the UE can select the set of beams based at least in part on the set of beams being associated with favorable characteristics (e.g., a satisfactory receive power, a satisfactory signal-to-noise-plus-interference-ratio (SINR) value). The UE can generate a codeword that indicates the set of beams and parameters to be used for using a codebook based at least in part on performing channel estimation of the channel between the network node and the UE.

One such codebook is the type-II codebook, prescribed in 5G/NR. The type-II codebook can use a two-stage procedure to generate the codeword: a first stage wherein the set of beams is selected for a wideband of the communication link (e.g., sometimes referred to herein as W1), and a second stage wherein linear combination is performed, for a set of subbands, using the set of beams for each set of subbands. The codeword can be based at least in part on the linear combination, and can indicate the set of beams and/or respective amplitudes, phase coefficients, and/or the like. Thus, the UE can provide an indication of channel state at the UE and can request the set of beams to be used for the UE. The type-II codebook can provide more precise specification of the channel state than a type-I codebook, which can provide a predefined codeword-based approach to specifying selected beams. Thus, the type-II codebook can be referred to as a high resolution codebook in comparison to the type-I codebook. The type-II codebook can improve MU-MIMO performance on the communication link.

For one type of type-II codebook (e.g., the codebook specified in Release 15 of the 3GPP standard for 5G/NR), the precoder of the codebook is based at least in part on a linear combination of discrete Fourier transform (DFT) beams. The linear combination may define the precoder W as W=W₁W₂, wherein the spatial domain compression matrix

$${W}_{1} = [ \begin{matrix}{v}_{0} {v}_{1} … {v}_{L - 1} & 0 \\ 0 & {v}_{0} {v}_{1} … {v}_{L - 1}\end{matrix} ] ,$$

wherein

$${\{ {v}_{i} \}}_{i = 0}^{L - 1}$$

are L spatial domain basis vectors of dimension N₁N₂×1 (mapped to the two polarizations, so 2L in total), P=2N₁N₂ indicates a number of dimensions (sometimes represented as D), and the combination coefficient matrix W₂ is composed of K=2Lν linear combination coefficients, where ν indicates a total number of layers. Each column in W₂ indicates the linear combination of complex coefficients (i.e., amplitude and phase) for one layer, wherein the amplitude coefficient is given by

$${\{ {p}_{i}^{( 1 )} {p}_{i}^{( 2 )} \}}_{i = 0}^{2 L - 1}$$

for l=0, . . . , v−1, and

$${p}_{i}^{( 1 )} and {p}_{i}^{( 2 )}$$

are the wideband and subband coefficients, respectively. The phase coefficient is given by

$${\{ {c}_{l , i} \}}_{i = 0}^{2 L - 1}$$

for l=0, . . . , v−1, and cᵢ is one of the 8 phase shift keying (8PSK) or the quadrature phase shift keying (QPSK) constellation points.

The UE can report the above values and/or other values associated with channel estimation using CSI feedback. CSI feedback for the type-II codebook can include two parts: a first part, sometimes referred to as CSI part I, and a second part, sometimes referred to as CSI part II. In some cases, the first part can have a smaller payload than the second part, and/or can have a fixed payload. For example, the first part can have a payload size of less than approximately 50 bits, whereas the second part can have a variable payload size that may be dependent on the first part. In some cases, the second part can have a payload size of approximately 100 bits to 600 bits, although other values can be used.

In some cases, the first part can identify one or more of: a rank indicator (RI) (e.g., 1 bit to indicate one layer ν=1 or two layers ν=2 when the configured maximum rank is 2); wideband and subband differential CQIs, for which a total payload size may be dependent on the number of subbands (e.g., approximately 4+18×2=40 bits for 19 subbands); and/or an indication of the number of non-zero wideband amplitude coefficients Qₗ for each layer; among other examples. In some cases, the second part can identify one or more of: wideband and/or subband precoding matrix indicators (PMIs) including a spatial basis vector selection indication; wideband and subband amplitude coefficients; and/or subband phase coefficients; among other examples.

In some cases, the type-II CSI feedback can use a compressed type-II precoder. This can reduce overhead of type-II CSI feedback. The compressed precoder can exploit the sparsity of the spatial domain and/or the frequency domain. For example, an example of a compressed type-II precoder W is given by

$$W = {W}_{1} {\tilde{W}}_{2} {W}_{f}^{H} ,$$

wherein the precoder matrix W has P=2N₁N₂ rows (representing the spatial domain and the number of ports) and N₃ columns (wherein N₃ is a frequency-domain compression unit of resource blocks or reporting subbands). The W₁ matrix, described above, is the spatial basis consisting of L beams per polarization group (hence a total of 2L beams). The \tilde{W}₂ matrix indicates all of the required linear combination complex coefficients (amplitude and co-phasing), referred to herein as “CSI coefficients”, similarly to what is described above. The W_{f} matrix is composed of the basis vectors used to perform compression in frequency domain, W_{f}=[f₀ f₁ . . . f_{M-1}], where

$${\{ {f}_{m} \}}_{m = 0}^{M - 1}$$

are M size-N₃×1 orthogonal DFT vectors for each spatial basis i=0, . . . , 2L−1. The above type-II CSI feedback may be referred to in some cases as enhanced or modified type-II CSI feedback (e.g., enhanced relative to an approach that does not use basis vectors in the spatial and frequency domains to compress feedback size).

The CSI feedback for this enhanced type-II CSI feedback can include a spatial domain basis vector selection that is similar to the approach described in connection with the type-II CSI feedback configuration. The CSI feedback can further include a frequency-domain (FD) basis subset selection (wherein M out of a total N₃ basis vectors are selected). In some cases, common FD basis vectors for all the 2L spatial beams can be used, which is referred to herein as Alternative 1. In these cases, M basis vectors are dynamically selected and reported. The value of M can be configured by the network or reported by the UE. In other cases, referred to herein as Alternative 2, independent FD basis vectors can be used for each spatial domain basis vector, with potentially different numbers and/or selections of FD basis vectors for each spatial domain basis vector. The total number of FD basis vectors across all the 2L spatial beams can be configured.

The enhanced type-II CSI feedback may further include the FD coefficients (e.g., amplitude and phase) in \tilde{W}₂. For Alternative 1 (the common FD basis vector subset selection), the enhanced type-II CSI feedback can report only a subset K₀<K=2LM of the coefficients. For Alternative 2 (the independent basis subset selection), the enhanced type-II CSI feedback can report

$$K = {\sum }_{i = 0}^{2 L - 1} {M}_{i}$$

amplitude and phase coefficients, wherein Mi is the number of FD basis vectors associated with one spatial beam.

A UE can communicate with a number of TRPs using beams. A TRP is a network node configured to transmit and receive signals. For example, a TRP can include one or more components of a base station. In some cases, a UE can communicate with multiple TRPs (mTRPs) simultaneously (e.g., at the same time) in accordance with an mTRP configuration. In mTRP downlink communications, the UE can receive a number of communications, each from a different TRP.

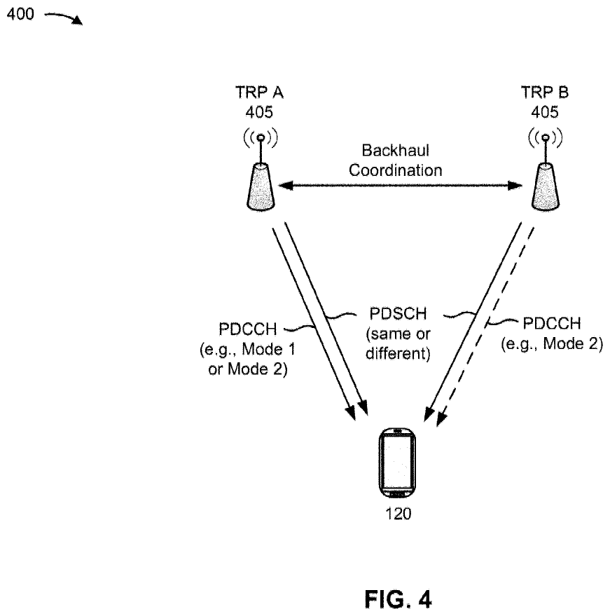

FIG. 4 is a diagram illustrating an example 400 of mTRP communication (sometimes referred to as multi-panel communication), in accordance with the present disclosure. As shown in FIG. 4, multiple TRPs 405 can communicate with the same UE 120. A network node can include multiple TRPs 405, or multiple TRPs 405 can be distributed across multiple network nodes.

The multiple TRPs 405 (shown as TRP A and TRP B) can communicate with the same UE 120 in a coordinated manner (e.g., using coordinated multipoint transmissions) to improve reliability and/or increase throughput. The TRPs 405 can coordinate such communications via an interface between the TRPs 405 (e.g., a backhaul interface and/or an access node controller). The interface can have a smaller delay and/or higher capacity when the TRPs 405 are co-located at the same network node (e.g., when the TRPs 405 are different antenna arrays or panels of the same network node), and can have a larger delay and/or lower capacity (as compared to co-location) when the TRPs 405 are located at different network nodes. The different TRPs 405 can communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) can be used to schedule downlink data communications for a single PDSCH. In this case, multiple TRPs 405 (e.g., TRP A and TRP B) can transmit communications to the UE 120 on the same PDSCH. For example, a communication can be transmitted using a single codeword with different spatial layers for different TRPs 405 (e.g., where one codeword maps to a first set of layers transmitted by a first TRP 405 and maps to a second set of layers transmitted by a second TRP 405). As another example, a communication can be transmitted using multiple codewords, where different codewords are transmitted by different TRPs 405 (e.g., using different sets of layers). In either case, different TRPs 405 can use different QCL relationships (e.g., different TCI states) for different DMRS ports corresponding to different layers. For example, a first TRP 405 can use a first QCL relationship or a first TCI state for a first set of DMRS ports corresponding to a first set of layers, and a second TRP 405 can use a second (different) QCL relationship or a second (different) TCI state for a second (different) set of DMRS ports corresponding to a second (different) set of layers. In some aspects, a TCI state in DCI (e.g., transmitted on the PDCCH, such as DCI format 1_0 or DCI format 1_1) can indicate the first QCL relationship (e.g., by indicating a first TCI state) and the second QCL relationship (e.g., by indicating a second TCI state). The first and the second TCI states can be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs can be used to schedule downlink data communications for multiple corresponding PDSCHs (e.g., one PDCCH for each PDSCH). In this case, a first PDCCH can schedule a first codeword to be transmitted by a first TRP 405, and a second PDCCH can schedule a second codeword to be transmitted by a second TRP 405. Furthermore, first DCI (e.g., transmitted by the first TRP 405) can schedule a first PDSCH communication associated with a first set of DMRS ports with a first QCL relationship (e.g., indicated by a first TCI state) for the first TRP 405, and second DCI (e.g., transmitted by the second TRP 405) can schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) can indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

Each communication in an mTRP configuration can be a spatial layer of a joint communication associated with a PDSCH. A joint communication is a communication that includes more than one signal that shares one or more time resources. Each TRP can be disposed at a different location than each other TRP and, as a result, each respective communication can be associated with one or more different respective spatial resources. Thus, each respective communication can be a spatial layer of the joint communication. A spatial layer of a joint communication is a portion of the joint communication that corresponds to a set of spatial resources. For example, a joint communication can include a first spatial layer corresponding to a first set of spatial resources and a second spatial layer corresponding to a second set of spatial resources.

To receive a joint communication from the multiple TRPs, a single wide beam corresponding to a single TCI state can be used. However, the single wide beam can result in application of a single spatial filter that applies to all of the layers of the joint communication, which may not be coherent (e.g., the layers of the joint communication may not have respective phases such that the layers can be constructively combined at a receiving device). A spatial filter is a mechanism (e.g., a process, procedure, circuitry, and/or software, among other examples) used to direct an electromagnetic signal into a certain path. In some cases, a CJT configuration can be used for a coherent joint communication to facilitate more efficient application of spatial filters, which can result in fewer missed signals and more spectral efficiency.

A CJT configuration can be used for PDSCH communications, physical uplink control channel (PUCCH) communications, and/or physical uplink shared channel (PUSCH) communications. A CJT is a joint transmission in which each layer of the joint transmission is transmitted with a respective phase such that the layers can be constructively combined at a receiving device.

In some cases, an mTRP CJT codebook can be used for port selection in mTRP CJT scenarios. In some cases, the mTRP CJT codebook can be from the Rel-16 eType-II CSI codebook or the Rel-17 FeType-II CSI port selection codebook. One of the differences of the FeType-II codebook compared with the eType-II codebook is the FD basis selection. In the eType-II codebook, when N₃≤19, the FD basis is arbitrarily selected in the whole FD domain and when N₃>19, the FD basis is selected in a rather large window in the two sides of FD basis 0. In the FeType-II codebook, regardless of the number of PMI Subbands (N₃), when M=2, the FD basis selection window is basis {0,1} (when N=2) or {0,1,2,3} (when N=4). Thus, FD basis 0 is always selected and the other candidate bases are close to basis 0 (e.g., each FD basis window starts from FD basis 0).

In some cases, due to differences in the propagation paths of signals received from the TRP A and TRP B, the downlink timing of the signals may be mis-aligned. For example, downlink timing misalignment may result from inter-TRP time synchronization error and/or propagation delay differences between the UE 120 and the two TRPs. In some cases, downlink timing differences among TRPs may vary over time due to independent clock drift in the TRP A and the TRB B and/or movement of the UE 120, which may lead to time-varying propagation delay differences between the UE 120 and the two TRPs.

In some cases, with CJT precoding, the UE 120 can observe a composite channel with large delay spread on a PDSCH demodulation reference signal (DMRS). A resolvable delay span D of eType-II CSI feedback can be determined by the bandwidth of the precoding matrix indicator (PMI) subband. Additionally, in the delay domain, taps larger than a resolvable delay span can be aliased. For example, with R=2, where there are 2 PMI subbands per channel quality indicator (CQI) subband, the resolvable delay span can be doubled. With N3 frequency domain (FD) bases, each FD basis represents one delay tap with D/N3 granularity.

In some cases, with eType-II CSI feedback, precoding for all tones within a subband can be quantized to a common coefficient. Without aliasing, a quantized precoding coefficient for tones within a subband can be a reasonable approximation. However, when there is an aliasing, the desired precoding coefficients for tones within a subband may show large variation. Thus, quantization to a common coefficient for all tones within a subband may not provide a reasonable precoding, without the timing misalignment being compensated.

Some aspects of the techniques and apparatuses described herein may facilitate reference signal timing offset reporting for mTRP CJT CSI feedback. For example, in some aspects, a network node may configure a UE to provide inter-TCI downlink timing offset information associated with reference signals. The reference signals may include synchronization signal blocks (SSBs) and/or tracking reference signals (TRSs), and the inter-TCI downlink timing offset information may be used to facilitate compensating timing associated with subsequent channel state information reference signals (CSI-RSs) and/or other communications. For example, based on reported inter-TCI downlink timing offset information, the network node may transmit CSI-RSs based on an inter-TCI downlink timing offset compensation. In some other aspects, the network node may configure the UE to report inter-CSI-RS for CSI measurement (inter-CMR) downlink timing offset information. For example, the network node may transmit CMRs and the UE may report inter-CMR downlink timing offset information as part of a CSI report. Based on the inter-CMR downlink timing offset information, the network node may transmit, via a physical downlink shared channel (PDSCH) and/or a physical downlink control channel (PDCCH), a communication based on an inter-CMR downlink timing offset compensation. In this way, some aspects may facilitate compensating for misalignment between downlink timing associated with multiple TRPs, thus facilitating more efficient quantization of CSI and/or more reliable communications, and thereby positively impacting device and/or network performance.

As indicated above, FIG. 4 is provided as an example. Other examples may differ from what is described with regard to FIG. 4.

FIG. 5 is a diagram illustrating an example 500 associated with reference signal timing offset reporting for mTRP CJT CSI feedback, in accordance with the present disclosure. As shown in FIG. 5, a UE 502 and a network node 504 may communicate with one another. In some aspects, the UE 502 may be, be similar to, include, or be included in, the UE 120 depicted in FIGS. 1-4. In some aspects, the network node 504 may be, be similar to, include, or be included in, the network node 110 depicted in FIGS. 1, 2, and 4, and/or one or more components of the disaggregated base station architecture 300 depicted in FIG. 3. The network node 504 may be or include a plurality of TRPs.

As shown by reference number 506, the network node 504 may transmit, and the UE 502 may receive, configuration information. The configuration information may be associated with reporting CSI associated with a plurality of TRPs for mTRP CJT. In some aspects, the configuration information may be associated with an inter-TCI downlink timing offset reporting operation. The inter-TCI downlink timing offset reporting operation may be an operation, performed by the UE 502, for reporting inter-TCI downlink timing offset information. The inter-TCI downlink timing offset information may indicate a downlink timing offset associated with at least one of a first TCI state or a second TCI state (or any number of other TCI states).

In some aspects, the inter-TCI downlink timing offset information associated with the first TCI state and/or the second TCI state may be based on a reference TCI state. For example, the inter-TCI downlink timing offset information may include a timing difference between a first timing associated with the first TCI state and a second timing associated with the second TCI state. The first timing and the second timing may each be determined based on a reference TCI state. In some aspects, for example, the configuration information may indicate the reference TCI state. In some other aspects, a wireless communication standard may specify the reference TCI state. In some aspects, the reference TCI state may include an activated TCI state, of a plurality of activated TCI states, having a TCI state index that satisfies a reference TCI state condition (e.g., a lowest TCI state index of a plurality of TC indices associated with the plurality of activated TCI states). In some aspects, the reference TCI state may include an activated TCI state, of a plurality of activated TCI states, having an associated reference signal received power (RSRP) that satisfies a reference TCI state condition. For example, the reference TCI state may be an activated TCI state having a highest RSRP of a plurality of RSRPs associated with the plurality of activated TCI states.

In some aspects, the configuration information may indicate a reporting periodicity associated with the inter-TCI downlink timing offset reporting operation. For example, the inter-TCI downlink timing offset information may be reported periodically and the configuration information may indicate a reporting periodicity. For example, the configuration information may indicate a number of milliseconds between each report. In some aspects, the configuration information or a subsequent trigger communication may trigger aperiodic reporting of inter-TCI downlink timing offset information. In some aspects, the configuration information may configure event-triggered reporting. For example, the configuration information may indicate a trigger event for triggering the inter-TCI downlink timing offset reporting operation. In some aspects, for example, the trigger event may be a determination that an inter-TCI downlink timing offset satisfies a reporting condition (e.g., the inter-TCI downlink timing offset exceeds a threshold).

As shown by reference number 508, the network node 504 may transmit, and the UE 502 may receive, a first reference signal associated with a first TCI state and, as shown by reference number 510, the network node 504 may transmit, and the UE 502 may receive, a second reference signal associated with a second TCI state. The reference signals may be associated with (e.g., transmitted by) a plurality of TRPs. In some aspects, the first reference signal may include a first periodic downlink reference signal and the second reference signal may include a second periodic downlink reference signal. In some aspects, for example, the first reference signal and/or the second reference signal may be an SSB or a TRS. In some aspects, the network node 504 may transmit any number of additional reference signals.

As shown by reference number 512, in some aspects, the UE 502 may detect an occurrence of a trigger event. For example, as described above, the detection of the occurrence of the trigger event may include a determination that the downlink timing offset satisfies a reporting condition (e.g., exceeds a reporting threshold). As shown by reference number 514, the UE 502 may transmit, and the network node 504 may receive, inter-TCI downlink timing offset information. The inter-TCI downlink timing offset information may be based on the configuration information and the first and second reference signals. The inter-TCI downlink timing offset information may indicate a downlink timing offset associated with at least one of the first TCI state or the second TCI state. In some aspects, the downlink timing offset may include a timing difference measurement between a first timing associated with the first TCI state and a second timing associated with the second TCI state. In some aspects, the first timing and/or the second timing may be based on a reference timing associated with a reference TCI state.

In some aspects, the UE 502 may transmit the inter-TCI downlink timing offset information by transmitting a quantized downlink timing offset. For example, the quantized downlink timing offset may include at least one resolvable delay span associated with enhanced Type-II CSI feedback. In some aspects, the quantized downlink timing offset may include at least one frequency domain basis delay unit associated with enhanced Type-II CSI feedback.

As shown by reference number 516, the network node 504 may transmit, and the UE 502 may receive, at least one CSI-RS based on an inter-TCI downlink timing offset compensation. The inter-TCI downlink timing offset compensation may be based on the inter-TCI downlink timing offset information. For example, the inter-TCI downlink timing offset compensation may include a per-UE cyclic shift of time domain samples associated with a post inverse Fast Fourier Transform (post-iFFT) processing signal. In some aspects, the inter-TCI downlink timing offset compensation may include a per-UE phase ramping of frequency domain samples associated with a pre-iFFT processing signal.

As shown by reference number 518, the network node 504 may transmit, and the UE 502 may receive, a communication based on an inter-TCI downlink timing offset compensation. The inter-TCI downlink timing offset compensation may be based on the inter-TCI downlink timing offset information, as described above in connection with the at least one CSI-RS. In some aspects, receiving the communication may include receiving the communication via at least one of a PDCCH or a PDSCH.

As indicated above, FIG. 5 is provided as an example. Other examples may differ from what is described with regard to FIG. 5.

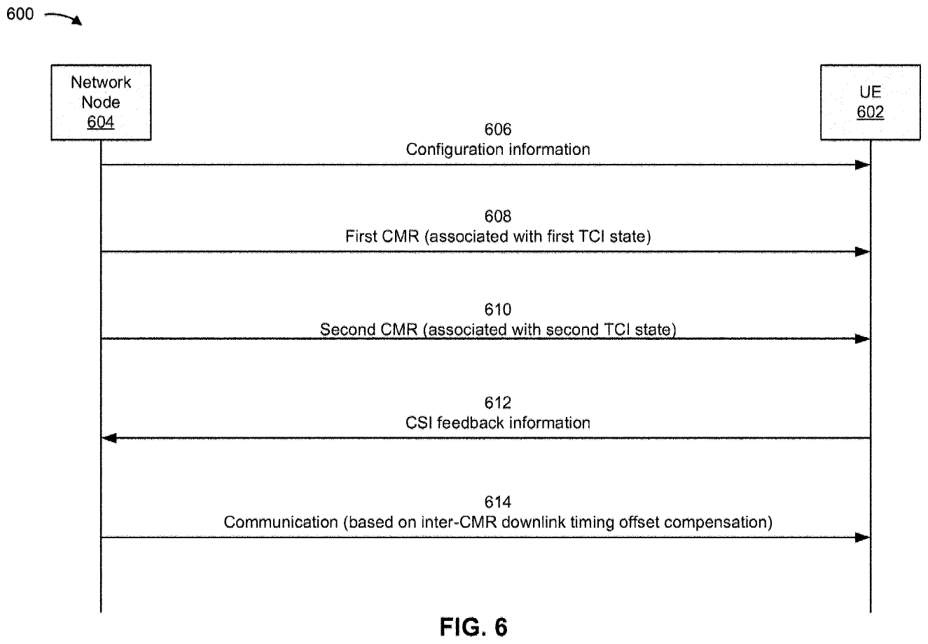

FIG. 6 is a diagram illustrating an example 600 associated with reference signal timing offset reporting for mTRP CJT CSI feedback, in accordance with the present disclosure. As shown in FIG. 6, a UE 602 and a network node 604 may communicate with one another. In some aspects, the UE 602 may be, be similar to, include, or be included in, the UE 502 depicted in FIG. 5, and/or the UE 120 depicted in FIGS. 1-4. In some aspects, the network node 604 may be, be similar to, include, or be included in, the network node 504 depicted in FIG. 5, the network node 110 depicted in FIGS. 1, 2, and 4, and/or one or more components of the disaggregated base station architecture 300 depicted in FIG. 3. The network node 604 may be or include a plurality of TRPs.

As shown by reference number 606, the network node 604 may transmit, and the UE 602 may receive, configuration information. The configuration information may be associated with reporting CSI associated with a plurality of TRPs for mTRP CJT. In some aspects, the configuration information may be associated with an inter-CMR downlink timing offset reporting operation. The inter-CMR downlink timing offset reporting operation may be an operation, performed by the UE 602, for reporting inter-CMR downlink timing offset information. The inter-CMR downlink timing offset information may indicate a downlink timing offset associated with at least one of a first CMR or a second CMR (or any number of other CMRs).

For example, the timing offset may include a timing difference measurement between a first timing associated with a first CMR and a second timing associated with a second CMR. In some aspects, the first timing and/or the second timing may be based on a reference timing associated with a reference CMR index. In some aspects, the configuration information may indicate the reference CMR index. For example, in some aspects, the configuration information may include an explicit indication of the reference CMR index. In some other aspects, the configuration information may indicate that the reference CMR index includes a CMR index of a plurality of CMR indices that satisfies a CMR reference condition. For example, the reference CMR index may be the CMR index associated with a strongest spatial domain basis.

As shown by reference number 608, the network node 604 may transmit, and the UE 602 may receive, a first CMR associated with a first TRP. As shown by reference number 610, the network node 604 may transmit, and the UE 602 may receive, a second CMR associated with a second TRP. As shown by reference number 612, the UE 602 may transmit, and the network node 604 may receive, CSI feedback information based on the first and second CMRs. The UE 602 may transmit the CSI feedback information based on the configuration information.

In some aspects, for example, the CSI feedback information may be included in a Type-II CJT CSI report. In some aspects, the CSI feedback information may indicate the reference CMR index. In some aspects, the reference CMR index may be a CMR index, of a plurality of CMR indices, that satisfies a reference CMR index condition. In some aspects, the CSI feedback information may include inter-CMR downlink timing offset information indicating a timing offset associated with at least one of the first CMR or the second CMR. In some aspects, the inter-CMR downlink timing offset information may indicate a downlink timing offset including a timing difference between a first timing associated with the first CMR and a second timing associated with the reference CMR index. In some aspects, the CSI feedback information may include a reporting bitmap that indicates, for each of a plurality of CMRs that includes the first CMR and the second CMR, a timing offset reporting state. The timing offset reporting state may indicate whether inter-CMR downlink timing is reported for an indicated CMR. In some aspects, whether the inter-CMR downlink timing is reported may be based on the presence of non-zero CSI coefficients associated with the CMR. In some aspects, the CSI feedback information may include the inter-CMR downlink timing offset information based on a reporting condition being satisfied. For example, in some aspects, the UE 602 may omit the inter-CMR timing downlink timing offset information when the measured timing offset is lower than a threshold.

In some aspects, the inter-CMR downlink timing offset information may be reported as a quantization of the timing offset. For example, in some aspects, the quantization of the timing offset may include at least one resolvable delay span associated with enhanced Type-II CSI feedback. In some aspects, the quantization of the timing offset may include at least one frequency domain basis delay unit associated with enhanced Type-II CSI feedback.

As shown by reference number 614, the network node 604 may transmit, and the UE 602 may receive, a communication based on an inter-CMR downlink timing offset compensation. In some aspects, the communication may be received via a PDCCH and/or a PDSCH. In some aspects, the inter-CMR downlink timing offset compensation may be based on the inter-CMR downlink timing offset information. For example, in some aspects, the inter-CMR downlink timing offset compensation may include a per-UE cyclic shift of time domain samples associated with a post-iFFT processing signal. In some other aspects, the inter-CMR downlink timing offset compensation may include a per-UE phase ramping of frequency domain samples associated with a pre-iFFT processing signal.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with reference signal timing offset reporting for mTRP CJT CSI feedback.

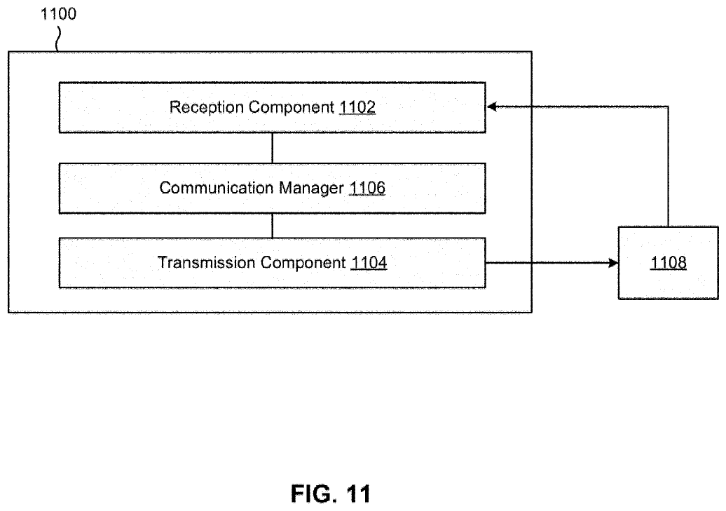

As shown in FIG. 7, in some aspects, process 700 may include receiving configuration information associated with an inter-TCI downlink timing offset reporting operation (block 710). For example, the UE (e.g., using reception component 1102 and/or communication manager 1106, depicted in FIG. 11) may receive configuration information associated with an inter-TCI downlink timing offset reporting operation, as described above.

As further shown in FIG. 7, in some aspects, process 700 may include receiving a first reference signal associated with a first TCI state (block 720). For example, the UE (e.g., using reception component 1102 and/or communication manager 1106, depicted in FIG. 11) may receive a first reference signal associated with a first TCI state, as described above.

As further shown in FIG. 7, in some aspects, process 700 may include receiving a second reference signal associated with a second TCI state (block 730). For example, the UE (e.g., using reception component 1102 and/or communication manager 1106, depicted in FIG. 11) may receive a second reference signal associated with a second TCI state, as described above.

As further shown in FIG. 7, in some aspects, process 700 may include transmitting, based on the configuration information, inter-TCI downlink timing offset information indicating a downlink timing offset associated with at least one of the first TCI state or the second TCI state (block 740). For example, the UE (e.g., using transmission component 1104 and/or communication manager 1106, depicted in FIG. 11) may transmit, based on the configuration information, inter-TCI downlink timing offset information indicating a downlink timing offset associated with at least one of the first TCI state or the second TCI state, as described above.

Process 700 may include additional aspects, such as any single aspect or any combination of aspects described below and/or in connection with one or more other processes described elsewhere herein.

In a first aspect, the first reference signal comprises a first periodic downlink reference signal and the second reference signal comprises a second periodic downlink reference signal. In a second aspect, alone or in combination with the first aspect, at least one of the first reference signal or the second reference signal comprises at least one of a synchronization signal block or a tracking reference signal. In a third aspect, alone or in combination with one or more of the first and second aspects, process 700 includes receiving at least one additional reference signal, wherein the inter-TCI downlink timing offset information indicates at least one additional downlink timing offset associated with the at least one additional reference signal.

In a fourth aspect, alone or in combination with one or more of the first through third aspects, the downlink timing offset comprises a timing difference measurement between a first timing associated with the first TCI state and a second timing associated with the second TCI state. In a fifth aspect, alone or in combination with one or more of the first through fourth aspects, the first timing is based on a reference timing associated with a reference TCI state. In a sixth aspect, alone or in combination with one or more of the first through fifth aspects, the configuration information indicates the reference TCI state. In a seventh aspect, alone or in combination with one or more of the first through sixth aspects, the reference TCI state comprises an activated TCI state, of a plurality of activated TCI states, having a TCI state index that satisfies a reference TCI state condition. In an eighth aspect, alone or in combination with one or more of the first through seventh aspects, the reference TCI state comprises an activated TCI state, of a plurality of activated TCI states, having an associated RSRP that satisfies a reference TCI state condition.

In a ninth aspect, alone or in combination with one or more of the first through eighth aspects, transmitting the inter-TCI downlink timing offset information comprises transmitting a quantized downlink timing offset. In a tenth aspect, alone or in combination with one or more of the first through ninth aspects, the quantized downlink timing offset comprises at least one resolvable delay span associated with enhanced Type-II CSI feedback. In an eleventh aspect, alone or in combination with one or more of the first through tenth aspects, the quantized downlink timing offset comprises at least one frequency domain basis delay unit associated with enhanced Type-II CSI feedback.

In a twelfth aspect, alone or in combination with one or more of the first through eleventh aspects, the configuration information indicates a reporting periodicity associated with the inter-TCI downlink timing offset reporting operation. In a thirteenth aspect, alone or in combination with one or more of the first through twelfth aspects, the inter-TCI downlink timing offset reporting operation comprises an aperiodic reporting operation. In a fourteenth aspect, alone or in combination with one or more of the first through thirteenth aspects, the configuration information indicates a trigger event for triggering the inter-TCI downlink timing offset reporting operation, and transmitting the inter-TCI downlink timing offset information comprises transmitting the inter-TCI downlink timing offset information based on a detection of an occurrence of the trigger event. In a fifteenth aspect, alone or in combination with one or more of the first through fourteenth aspects, the detection of the occurrence of the trigger event comprises a determination that the downlink timing offset satisfies a reporting condition.

In a sixteenth aspect, alone or in combination with one or more of the first through fifteenth aspects, process 700 includes receiving at least one CSI-RS based on an inter-TCI downlink timing offset compensation, wherein the inter-TCI downlink timing offset compensation is based on the inter-TCI downlink timing offset information. In a seventeenth aspect, alone or in combination with one or more of the first through sixteenth aspects, process 700 includes receiving a communication based on an inter-TCI downlink timing offset compensation, wherein the inter-TCI downlink timing offset compensation is based on the inter-TCI downlink timing offset information. In an eighteenth aspect, alone or in combination with one or more of the first through seventeenth aspects, receiving the communication comprises receiving the communication via at least one of a PDCCH or a PDSCH.

In a nineteenth aspect, alone or in combination with one or more of the first through eighteenth aspects, the inter-TCI downlink timing offset compensation comprises a per-UE cyclic shift of time domain samples associated with a post-iFFT processing signal. In a twentieth aspect, alone or in combination with one or more of the first through nineteenth aspects, the inter-TCI downlink timing offset compensation comprises a per-UE phase ramping of frequency domain samples associated with a pre-iFFT processing signal.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with reference signal timing offset reporting for mTRP CJT CSI feedback.

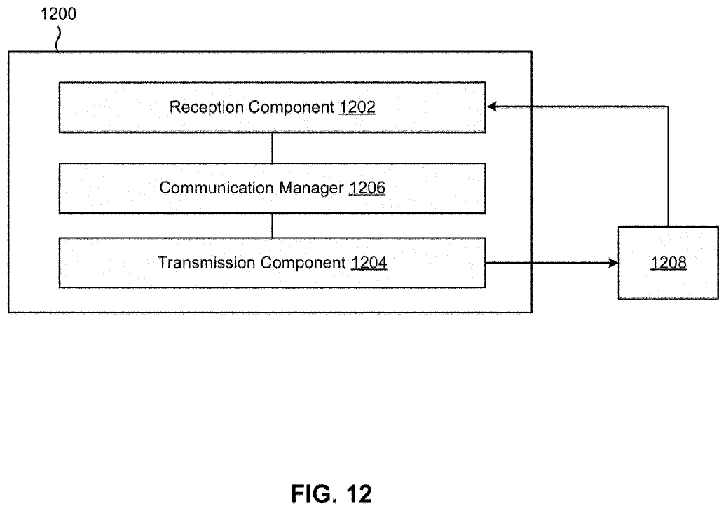

As shown in FIG. 8, in some aspects, process 800 may include transmitting configuration information associated with an inter-TCI downlink timing offset reporting operation (block 810). For example, the network node (e.g., using transmission component 1204 and/or communication manager 1206, depicted in FIG. 12) may transmit configuration information associated with an inter-TCI downlink timing offset reporting operation, as described above.

As further shown in FIG. 8, in some aspects, process 800 may include transmitting a first reference signal associated with a first TCI state (block 820). For example, the network node (e.g., using transmission component 1204 and/or communication manager 1206, depicted in FIG. 12) may transmit a first reference signal associated with a first TCI state, as described above.

As further shown in FIG. 8, in some aspects, process 800 may include transmitting a second reference signal associated with a second TCI state (block 830). For example, the network node (e.g., using transmission component 1204 and/or communication manager 1206, depicted in FIG. 12) may transmit a second reference signal associated with a second TCI state, as described above.

As further shown in FIG. 8, in some aspects, process 800 may include receiving, based on the configuration information, inter-TCI downlink timing offset information indicating a downlink timing offset associated with at least one of the first TCI state or the second TCI state (block 840). For example, the network node (e.g., using reception component 1202 and/or communication manager 1206, depicted in FIG. 12) may receive, based on the configuration information, inter-TCI downlink timing offset information indicating a downlink timing offset associated with at least one of the first TCI state or the second TCI state, as described above.

Process 800 may include additional aspects, such as any single aspect or any combination of aspects described below and/or in connection with one or more other processes described elsewhere herein.

In a first aspect, the first reference signal comprises a first periodic downlink reference signal and the second reference signal comprises a second periodic downlink reference signal. In a second aspect, alone or in combination with the first aspect, at least one of the first reference signal or the second reference signal comprises at least one of a synchronization signal block or a tracking reference signal. In a third aspect, alone or in combination with one or more of the first and second aspects, process 800 includes transmitting at least one additional reference signal, wherein the inter-TCI downlink timing offset information indicates at least one additional downlink timing offset associated with the at least one additional reference signal.

In a fourth aspect, alone or in combination with one or more of the first through third aspects, the downlink timing offset comprises a timing difference measurement between a first timing associated with the first TCI state and a second timing associated with the second TCI state. In a fifth aspect, alone or in combination with one or more of the first through fourth aspects, the first timing is based on a reference timing associated with a reference TCI state. In a sixth aspect, alone or in combination with one or more of the first through fifth aspects, the configuration information indicates the reference TCI state. In a seventh aspect, alone or in combination with one or more of the first through sixth aspects, the reference TCI state comprises an activated TCI state, of a plurality of activated TCI states, having a TEC state index that satisfies a reference TCI state condition.

In an eighth aspect, alone or in combination with one or more of the first through seventh aspects, the reference TCI state comprises an activated TCI state, of a plurality of activated TCI states, having an associated RSRP that satisfies a reference TCI state condition. In a ninth aspect, alone or in combination with one or more of the first through eighth aspects, receiving the inter-TCI downlink timing offset information comprises receiving a quantized downlink timing offset. In a tenth aspect, alone or in combination with one or more of the first through ninth aspects, the quantized downlink timing offset comprises at least one resolvable delay span associated with enhanced Type-II CSI feedback. In an eleventh aspect, alone or in combination with one or more of the first through tenth aspects, the quantized downlink timing offset comprises at least one frequency domain basis delay unit associated with enhanced Type-II CSI feedback.

In a twelfth aspect, alone or in combination with one or more of the first through eleventh aspects, the configuration information indicates a reporting periodicity associated with the inter-TCI downlink timing offset reporting operation. In a thirteenth aspect, alone or in combination with one or more of the first through twelfth aspects, the inter-TCI downlink timing offset reporting operation comprises an aperiodic reporting operation. In a fourteenth aspect, alone or in combination with one or more of the first through thirteenth aspects, the configuration information indicates a trigger event for triggering the inter-TCI downlink timing offset reporting operation, and receiving the inter-TCI downlink timing offset information comprises receiving the inter-TCI downlink timing offset information based on a detection of an occurrence of the trigger event. In a fifteenth aspect, alone or in combination with one or more of the first through fourteenth aspects, the detection of the occurrence of the trigger event comprises a determination that the downlink timing offset satisfies a reporting condition.

In a sixteenth aspect, alone or in combination with one or more of the first through fifteenth aspects, process 800 includes transmitting at least one CSI-RS based on an inter-TCI downlink timing offset compensation, wherein the inter-TCI downlink timing offset compensation is based on the inter-TCI downlink timing offset information. In a seventeenth aspect, alone or in combination with one or more of the first through sixteenth aspects, process 800 includes transmitting a communication based on an inter-TCI downlink timing offset compensation, wherein the inter-TCI downlink timing offset compensation is based on the inter-TCI downlink timing offset information. In an eighteenth aspect, alone or in combination with one or more of the first through seventeenth aspects, transmitting the communication comprises transmitting the communication via at least one of a PDCCH or a PDSCH.

In a nineteenth aspect, alone or in combination with one or more of the first through eighteenth aspects, the inter-TCI downlink timing offset compensation comprises a per-UE cyclic shift of time domain samples associated with a post-iFFT processing signal. In a twentieth aspect, alone or in combination with one or more of the first through nineteenth aspects, the inter-TCI downlink timing offset compensation comprises a per-UE phase ramping of frequency domain samples associated with a pre-iFFT processing signal.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with reference signal timing offset reporting for mTRP CJT CSI feedback.

As shown in FIG. 9, in some aspects, process 900 may include receiving configuration information associated with an mTRP CJT CSI reporting operation, the configuration information indicating an inter-CMR downlink timing offset reporting operation (block 910). For example, the UE (e.g., using reception component 1102 and/or communication manager 1106, depicted in FIG. 11) may receive configuration information associated with an mTRP CJT CSI reporting operation, the configuration information indicating an inter-CMR downlink timing offset reporting operation, as described above.

As further shown in FIG. 9, in some aspects, process 900 may include receiving a first CMR associated with a first TRP (block 920). For example, the UE (e.g., using reception component 1102 and/or communication manager 1106, depicted in FIG. 11) may receive a first CMR associated with a first TRP, as described above.

As further shown in FIG. 9, in some aspects, process 900 may include receiving a second CMR associated with a second TRP (block 930). For example, the UE (e.g., using reception component 1102 and/or communication manager 1106, depicted in FIG. 11) may receive a second CMR associated with a second TRP, as described above.

As further shown in FIG. 9, in some aspects, process 900 may include transmitting, based on the configuration information, CSI feedback information that includes inter-CMR downlink timing offset information indicating a timing offset associated with at least one of the first CMR or the second CMR (block 940). For example, the UE (e.g., using transmission component 1104 and/or communication manager 1106, depicted in FIG. 11) may transmit, based on the configuration information, CSI feedback information that includes inter-CMR downlink timing offset information indicating a timing offset associated with at least one of the first CMR or the second CMR, as described above.

Process 900 may include additional aspects, such as any single aspect or any combination of aspects described below and/or in connection with one or more other processes described elsewhere herein.

In a first aspect, the timing offset comprises a timing difference measurement between a first timing associated with the first CMR and a second timing associated with the second CMR. In a second aspect, alone or in combination with the first aspect, the first timing is based on a reference timing associated with a reference CMR index. In a third aspect, alone or in combination with one or more of the first and second aspects, the configuration information indicates the reference CMR index. In a fourth aspect, alone or in combination with one or more of the first through third aspects, the configuration information comprises an explicit indication of the reference CMR index. In a fifth aspect, alone or in combination with one or more of the first through fourth aspects, the inter-CMR downlink timing offset information indicates a downlink timing offset comprising a timing difference between a first timing associated with the first CMR and a second timing associated with the reference CMR index. In a sixth aspect, alone or in combination with one or more of the first through fifth aspects, the configuration information indicates that the reference CMR index comprises a CMR index of a plurality of CMR indices that satisfies a CMR reference condition.

In a seventh aspect, alone or in combination with one or more of the first through sixth aspects, the CSI feedback information comprises a reporting bitmap that indicates, for each of a plurality of CMRs that includes the first CMR and the second CMR, a timing offset reporting state. In an eighth aspect, alone or in combination with one or more of the first through seventh aspects, the CSI feedback information includes the inter-CMR downlink timing offset information based on a reporting condition being satisfied.

In a ninth aspect, alone or in combination with one or more of the first through eighth aspects, the inter-CMR downlink timing offset information comprises a quantization of the timing offset. In a tenth aspect, alone or in combination with one or more of the first through ninth aspects, the quantization of the timing offset comprises at least one resolvable delay span associated with enhanced Type-II CSI feedback. In an eleventh aspect, alone or in combination with one or more of the first through tenth aspects, the quantization of the timing offset comprises at least one frequency domain basis delay unit associated with enhanced Type-II CSI feedback.

In a twelfth aspect, alone or in combination with one or more of the first through eleventh aspects, process 900 includes receiving a communication based on an inter-CMR downlink timing offset compensation, wherein the inter-CMR downlink timing offset compensation is based on the inter-CMR downlink timing offset information. In a thirteenth aspect, alone or in combination with one or more of the first through twelfth aspects, receiving the communication comprises receiving the communication via at least one of a PDCCH or a PDSCH. In a fourteenth aspect, alone or in combination with one or more of the first through thirteenth aspects, the inter-CMR downlink timing offset compensation comprises a per-UE cyclic shift of time domain samples associated with a post-iFFT processing signal. In a fifteenth aspect, alone or in combination with one or more of the first through fourteenth aspects, the inter-CMR downlink timing offset compensation comprises a per-UE phase ramping of frequency domain samples associated with a pre-iFFT processing signal.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110) performs operations associated with reference signal timing offset reporting for mTRP CJT CSI feedback.

As shown in FIG. 10, in some aspects, process 1000 may include transmitting configuration information associated with an mTRP CJT CSI reporting operation, the configuration information indicating an inter-CMR downlink timing offset reporting operation (block 1010). For example, the network node (e.g., using transmission component 1204 and/or communication manager 1206, depicted in FIG. 12) may transmit configuration information associated with an mTRP CJT CSI reporting operation, the configuration information indicating an inter-CMR downlink timing offset reporting operation, as described above.

As further shown in FIG. 10, in some aspects, process 1000 may include transmitting a first CMR associated with a first TRP (block 1020). For example, the network node (e.g., using transmission component 1204 and/or communication manager 1206, depicted in FIG. 12) may transmit a first CMR associated with a first TRP, as described above.

As further shown in FIG. 10, in some aspects, process 1000 may include transmitting a second CMR associated with a second TRP (block 1030). For example, the network node (e.g., using transmission component 1204 and/or communication manager 1206, depicted in FIG. 12) may transmit a second CMR associated with a second TRP, as described above.

As further shown in FIG. 10, in some aspects, process 1000 may include receiving, based on the configuration information, CSI feedback information that includes inter-CMR downlink timing offset information indicating a timing offset associated with at least one of the first CMR or the second CMR (block 1040). For example, the network node (e.g., using reception component 1202 and/or communication manager 1206, depicted in FIG. 12) may receive, based on the configuration information, CSI feedback information that includes inter-CMR downlink timing offset information indicating a timing offset associated with at least one of the first CMR or the second CMR, as described above.

Process 1000 may include additional aspects, such as any single aspect or any combination of aspects described below and/or in connection with one or more other processes described elsewhere herein.

In a first aspect, the timing offset comprises a timing difference measurement between a first timing associated with the first CMR and a second timing associated with the second CMR. In a second aspect, alone or in combination with the first aspect, the first timing is based on a reference timing associated with a reference CMR index. In a third aspect, alone or in combination with one or more of the first and second aspects, the configuration information indicates the reference CMR index. In a fourth aspect, alone or in combination with one or more of the first through third aspects, the configuration information comprises an explicit indication of the reference CMR index. In a fifth aspect, alone or in combination with one or more of the first through fourth aspects, the inter-CMR downlink timing offset information indicates a downlink timing offset comprising a timing difference between a first timing associated with the first CMR and a second timing associated with the reference CMR index. In a sixth aspect, alone or in combination with one or more of the first through fifth aspects, the configuration information indicates that the reference CMR index comprises a CMR index of a plurality of CMR indices that satisfies a CMR reference condition.

In a seventh aspect, alone or in combination with one or more of the first through sixth aspects, the CSI feedback information comprises a reporting bitmap that indicates, for each of a plurality of CMRs that includes the first CMR and the second CMR, a timing offset reporting state. In an eighth aspect, alone or in combination with one or more of the first through seventh aspects, the CSI feedback information includes the inter-CMR downlink timing offset information based on a reporting condition being satisfied. In a ninth aspect, alone or in combination with one or more of the first through eighth aspects, the inter-CMR downlink timing offset information comprises a quantization of the timing offset. In a tenth aspect, alone or in combination with one or more of the first through ninth aspects, the quantization of the timing offset comprises at least one resolvable delay span associated with enhanced Type-II CSI feedback. In an eleventh aspect, alone or in combination with one or more of the first through tenth aspects, the quantization of the timing offset comprises at least one frequency domain basis delay unit associated with enhanced Type-II CSI feedback.

In a twelfth aspect, alone or in combination with one or more of the first through eleventh aspects, process 1000 includes transmitting a communication based on an inter-CMR downlink timing offset compensation, wherein the inter-CMR downlink timing offset compensation is based on the inter-CMR downlink timing offset information. In a thirteenth aspect, alone or in combination with one or more of the first through twelfth aspects, transmitting the communication comprises transmitting the communication via at least one of a PDCCH or a PDSCH. In a fourteenth aspect, alone or in combination with one or more of the first through thirteenth aspects, the inter-CMR downlink timing offset compensation comprises a per-UE cyclic shift of time domain samples associated with a post-IFFT processing signal. In a fifteenth aspect, alone or in combination with one or more of the first through fourteenth aspects, the inter-CMR downlink timing offset compensation comprises a per-UE phase ramping of frequency domain samples associated with a pre-iFFT processing signal.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 5 and 6. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive configuration information associated with an inter-TCI downlink timing offset reporting operation. The reception component 1102 may receive a first reference signal associated with a first TCI state. The reception component 1102 may receive a second reference signal associated with a second TCI state. The transmission component 1104 may transmit, based on the configuration information, inter-TCI downlink timing offset information indicating a downlink timing offset associated with at least one of the first TCI state or the second TCI state. The reception component 1102 may receive at least one additional reference signal, wherein the inter-TCI downlink timing offset information indicates at least one additional downlink timing offset associated with the at least one additional reference signal. The reception component 1102 may receive at least one CSI-RS based on an inter-TCI downlink timing offset compensation, wherein the inter-TCI downlink timing offset compensation is based on the inter-TCI downlink timing offset information. The reception component 1102 may receive a communication based on an inter-TCI downlink timing offset compensation, wherein the inter-TCI downlink timing offset compensation is based on the inter-TCI downlink timing offset information.

The reception component 1102 may receive configuration information associated with an mTRP CJT CSI reporting operation, the configuration information indicating an inter-CMR downlink timing offset reporting operation. The reception component 1102 may receive a first CMR associated with a first TRP. The reception component 1102 may receive a second CMR associated with a second TRP. The transmission component 1104 may transmit, based on the configuration information, CSI feedback information that includes inter-CMR downlink timing offset information indicating a timing offset associated with at least one of the first CMR or the second CMR. The reception component 1102 may receive a communication based on an inter-CMR downlink timing offset compensation, wherein the inter-CMR downlink timing offset compensation is based on the inter-CMR downlink timing offset information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 5 and 6. Additionally, or alternatively, the apparatus 1200 may be configured to perform one or more processes described herein, such as process 800 of FIG. 8, process 1000 of FIG. 10, or a combination thereof. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit configuration information associated with an inter-TCI downlink timing offset reporting operation. The transmission component 1204 may transmit a first reference signal associated with a first TCI state. The transmission component 1204 may transmit a second reference signal associated with a second TCI state. The reception component 1202 may receive, based on the configuration information, inter-TCI downlink timing offset information indicating a downlink timing offset associated with at least one of the first TCI state or the second TCI state.

The transmission component 1204 may transmit at least one additional reference signal, wherein the inter-TCI downlink timing offset information indicates at least one additional downlink timing offset associated with the at least one additional reference signal. The transmission component 1204 may transmit at least one CSI-RS based on an inter-TCI downlink timing offset compensation, wherein the inter-TCI downlink timing offset compensation is based on the inter-TCI downlink timing offset information. The transmission component 1204 may transmit a communication based on an inter-TCI downlink timing offset compensation, wherein the inter-TCI downlink timing offset compensation is based on the inter-TCI downlink timing offset information.

The transmission component 1204 may transmit configuration information associated with an mTRP CJT CSI reporting operation, the configuration information indicating an inter-CMR downlink timing offset reporting operation. The transmission component 1204 may transmit a first CMR associated with a first TRP. The transmission component 1204 may transmit a second CMR associated with a second TRP. The reception component 1202 may receive, based on the configuration information, CSI feedback information that includes inter-CMR downlink timing offset information indicating a timing offset associated with at least one of the first CMR or the second CMR. The transmission component 1204 may transmit a communication based on an inter-CMR downlink timing offset compensation, wherein the inter-CMR downlink timing offset compensation is based on the inter-CMR downlink timing offset information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving configuration information associated with an inter-transmission configuration indication (TCI) downlink timing offset reporting operation; receiving a first reference signal associated with a first TCI state; receiving a second reference signal associated with a second TCI state; and transmitting, based on the configuration information, inter-TCI downlink timing offset information indicating a downlink timing offset associated with at least one of the first TCI state or the second TCI state.

Aspect 2: The method of Aspect 1, wherein the first reference signal comprises a first periodic downlink reference signal and the second reference signal comprises a second periodic downlink reference signal.

Aspect 3: The method of either of claim 1 or 2, wherein at least one of the first reference signal or the second reference signal comprises at least one of a synchronization signal block or a tracking reference signal.

Aspect 4: The method of any of Aspects 1-3, further comprising receiving at least one additional reference signal, wherein the inter-TCI downlink timing offset information indicates at least one additional downlink timing offset associated with the at least one additional reference signal.

Aspect 5: The method of any of Aspects 1-4, wherein the downlink timing offset comprises a timing difference measurement between a first timing associated with the first TCI state and a second timing associated with the second TCI state.

Aspect 6: The method of Aspect 5, wherein the first timing is based on a reference timing associated with a reference TCI state.

Aspect 7: The method of Aspect 6, wherein the configuration information indicates the reference TCI state.

Aspect 8: The method of either of Aspects 6 or 7, wherein the reference TCI state comprises an activated TCI state, of a plurality of activated TCI states, having a TCI state index that satisfies a reference TCI state condition.

Aspect 9: The method of any of Aspects 6-8, wherein the reference TCI state comprises an activated TCI state, of a plurality of activated TCI states, having an associated reference signal received power (RSRP) that satisfies a reference TCI state condition.

Aspect 10: The method of any of Aspects 1-9, wherein transmitting the inter-TCI downlink timing offset information comprises transmitting a quantized downlink timing offset.

Aspect 11: The method of Aspect 10, wherein the quantized downlink timing offset comprises at least one resolvable delay span associated with enhanced Type-II channel state information (CSI) feedback.

Aspect 12: The method of either of claim 10 or 11, wherein the quantized downlink timing offset comprises at least one frequency domain basis delay unit associated with enhanced Type-II channel state information (CSI) feedback.

Aspect 13: The method of any of Aspects 1-12, wherein the configuration information indicates a reporting periodicity associated with the inter-TCI downlink timing offset reporting operation.

Aspect 14: The method of any of Aspects 1-13, wherein the inter-TCI downlink timing offset reporting operation comprises an aperiodic reporting operation.

Aspect 15: The method of any of Aspects 1-14, wherein the configuration information indicates a trigger event for triggering the inter-TCI downlink timing offset reporting operation, and wherein transmitting the inter-TCI downlink timing offset information comprises transmitting the inter-TCI downlink timing offset information based on a detection of an occurrence of the trigger event.

Aspect 16: The method of Aspect 15, wherein the detection of the occurrence of the trigger event comprises a determination that the downlink timing offset satisfies a reporting condition.

Aspect 17: The method of any of Aspects 1-16, further comprising receiving at least one channel state information (CSI) reference signal (CSI-RS) based on an inter-TCI downlink timing offset compensation, wherein the inter-TCI downlink timing offset compensation is based on the inter-TCI downlink timing offset information.

Aspect 18: The method of any of Aspects 1-17, further comprising receiving a communication based on an inter-TCI downlink timing offset compensation, wherein the inter-TCI downlink timing offset compensation is based on the inter-TCI downlink timing offset information.

Aspect 19: The method of Aspect 18, wherein receiving the communication comprises receiving the communication via a physical downlink control channel (PDCCH) and physical downlink shared channel (PDSCH).

Aspect 20: The method of either of claim 18 or 19, wherein the inter-TCI downlink timing offset compensation comprises a per-UE cyclic shift of time domain samples associated with a post-inverse Fast Fourier Transform processing signal.

Aspect 21: The method of any of Aspects 18-20, wherein the inter-TCI downlink timing offset compensation comprises a per-UE phase ramping of frequency domain samples associated with a pre-inverse Fast Fourier Transform processing signal.

Aspect 22: A method of wireless communication performed by a network node, comprising: transmitting configuration information associated with an inter-transmission configuration indication (TCI) downlink timing offset reporting operation; transmitting a first reference signal associated with a first TCI state; transmitting a second reference signal associated with a second TCI state; and receiving, based on the configuration information, inter-TCI downlink timing offset information indicating a downlink timing offset associated with at least one of the first TCI state or the second TCI state.

Aspect 23: The method of Aspect 22, wherein the first reference signal comprises a first periodic downlink reference signal and the second reference signal comprises a second periodic downlink reference signal.

Aspect 24: The method of either of claim 22 or 23, wherein at least one of the first reference signal or the second reference signal comprises at least one of a synchronization signal block or a tracking reference signal.

Aspect 25: The method of any of Aspects 22-24, further comprising transmitting at least one additional reference signal, wherein the inter-TCI downlink timing offset information indicates at least one additional downlink timing offset associated with the at least one additional reference signal.

Aspect 26: The method of any of Aspects 22-25, wherein the downlink timing offset comprises a timing difference measurement between a first timing associated with the first TCI state and a second timing associated with the second TCI state.

Aspect 27: The method of Aspect 26, wherein the first timing is based on a reference timing associated with a reference TCI state.

Aspect 28: The method of Aspect 27, wherein the configuration information indicates the reference TCI state.

Aspect 29: The method of either of Aspects 27 or 28, wherein the reference TCI state comprises an activated TCI state, of a plurality of activated TCI states, having a TCI state index that satisfies a reference TCI state condition.

Aspect 30: The method of any of Aspects 27-29, wherein the reference TCI state comprises an activated TCI state, of a plurality of activated TCI states, having an associated reference signal received power (RSRP) that satisfies a reference TCI state condition.

Aspect 31: The method of any of Aspects 22-30, wherein receiving the inter-TCI downlink timing offset information comprises receiving a quantized downlink timing offset.

Aspect 32: The method of Aspect 31, wherein the quantized downlink timing offset comprises at least one resolvable delay span associated with enhanced Type-II channel state information (CSI) feedback.

Aspect 33: The method of either of claim 31 or 32, wherein the quantized downlink timing offset comprises at least one frequency domain basis delay unit associated with enhanced Type-II channel state information (CSI) feedback.

Aspect 34: The method of any of Aspects 22-33, wherein the configuration information indicates a reporting periodicity associated with the inter-TCI downlink timing offset reporting operation.

Aspect 35: The method of any of Aspects 22-34, wherein the inter-TCI downlink timing offset reporting operation comprises an aperiodic reporting operation.

Aspect 36: The method of any of Aspects 22-35, wherein the configuration information indicates a trigger event for triggering the inter-TCI downlink timing offset reporting operation, and wherein receiving the inter-TCI downlink timing offset information comprises receiving the inter-TCI downlink timing offset information based on a detection of an occurrence of the trigger event.

Aspect 37: The method of Aspect 36, wherein the detection of the occurrence of the trigger event comprises a determination that the downlink timing offset satisfies a reporting condition.

Aspect 38: The method of any of Aspects 22-37, further comprising transmitting at least one channel state information (CSI) reference signal (CSI-RS) based on an inter-TCI downlink timing offset compensation, wherein the inter-TCI downlink timing offset compensation is based on the inter-TCI downlink timing offset information.

Aspect 39: The method of any of Aspects 22-38, further comprising transmitting a communication based on an inter-TCI downlink timing offset compensation, wherein the inter-TCI downlink timing offset compensation is based on the inter-TCI downlink timing offset information.

Aspect 40: The method of Aspect 39, wherein transmitting the communication comprises transmitting the communication via a physical downlink control channel (PDCCH) and physical downlink shared channel (PDSCH).

Aspect 41: The method of either of claim 39 or 40, wherein the inter-TCI downlink timing offset compensation comprises a per-UE cyclic shift of time domain samples associated with a post-inverse Fast Fourier Transform processing signal.

Aspect 42: The method of any of Aspects 39-41, wherein the inter-TCI downlink timing offset compensation comprises a per-UE phase ramping of frequency domain samples associated with a pre-inverse Fast Fourier Transform processing signal.

Aspect 43: A method of wireless communication performed by a user equipment (UE), comprising: receiving configuration information associated with multiple transmission reception point (mTRP) coherent joint transmission (CJT) channel state information (CSI) reporting operation, the configuration information indicating an inter-CSI-RS for CSI measurement (inter-CMR) downlink timing offset reporting operation; receiving a first CMR associated with a first transmission reception point (TRP); receiving a second CMR associated with a second TRP; and transmitting, based on the configuration information, CSI feedback information that includes inter-CMR downlink timing offset information indicating a timing offset associated with at least one of the first CMR or the second CMR.

Aspect 44: The method of Aspect 43, wherein the timing offset comprises a timing difference measurement between a first timing associated with the first CMR and a second timing associated with the second CMR.

Aspect 45: The method of Aspect 44, wherein the first timing is based on a reference timing associated with a reference CMR index.

Aspect 46: The method of Aspect 45, wherein the configuration information indicates the reference CMR index.

Aspect 47: The method of Aspect 46, wherein the configuration information comprises an explicit indication of the reference CMR index.

Aspect 48: The method of Aspect 47, wherein the inter-CMR downlink timing offset information indicates a downlink timing offset comprising a timing difference between a first timing associated with the first CMR and a second timing associated with the reference CMR index.

Aspect 49: The method of any of Aspects 46-48, wherein the configuration information indicates that the reference CMR index comprises a CMR index of a plurality of CMR indices that satisfies a CMR reference condition.

Aspect 50: The method of any of Aspects 43-49, wherein the CSI feedback information comprises a reporting bitmap that indicates, for each of a plurality of CMRs that includes the first CMR and the second CMR, a timing offset reporting state.

Aspect 51: The method of any of Aspects 43-50, wherein the CSI feedback information includes the inter-CMR downlink timing offset information based on a reporting condition being satisfied.

Aspect 52: The method of any of Aspects 43-51, wherein the inter-CMR downlink timing offset information comprises a quantization of the timing offset.

Aspect 53: The method of Aspect 52, wherein the quantization of the timing offset comprises at least one resolvable delay span associated with enhanced Type-II channel state information (CSI) feedback.

Aspect 54: The method of either of claim 52 or 53, wherein the quantization of the timing offset comprises at least one frequency domain basis delay unit associated with enhanced Type-II channel state information (CSI) feedback.

Aspect 55: The method of any of Aspects 43-54, further comprising receiving a communication based on an inter-CMR downlink timing offset compensation, wherein the inter-CMR downlink timing offset compensation is based on the inter-CMR downlink timing offset information.

Aspect 56: The method of Aspect 55, wherein receiving the communication comprises receiving the communication via a physical downlink control channel (PDCCH) and physical downlink shared channel (PDSCH).

Aspect 57: The method of either of claim 55 or 56, wherein the inter-CMR downlink timing offset compensation comprises a per-UE cyclic shift of time domain samples associated with a post-inverse Fast Fourier Transform processing signal.

Aspect 58: The method of any of Aspects 55-57, wherein the inter-CMR downlink timing offset compensation comprises a per-UE phase ramping of frequency domain samples associated with a pre-inverse Fast Fourier Transform processing signal.

Aspect 59: A method of wireless communication performed by a network node, comprising: transmitting configuration information associated with a multiple transmission reception point (mTRP) coherent joint transmission (CJT) channel state information (CSI) reporting operations, the configuration information indicating an inter-CSI-RS for CSI measurement (inter-CMR) downlink timing offset reporting operation; transmitting a first CMR associated with a first transmission reception point (TRP); transmitting a second CMR associated with a second TRP; and receiving, based on the configuration information, CSI feedback information that includes inter-CMR downlink timing offset information indicating a timing offset associated with at least one of the first CMR or the second CMR.

Aspect 60: The method of Aspect 59, wherein the timing offset comprises a timing difference measurement between a first timing associated with the first CMR and a second timing associated with the second CMR.

Aspect 61: The method of Aspect 60, wherein the first timing is based on a reference timing associated with a reference CMR index.

Aspect 62: The method of Aspect 61, wherein the configuration information indicates the reference CMR index.

Aspect 63: The method of Aspect 62, wherein the configuration information comprises an explicit indication of the reference CMR index.

Aspect 64: The method of Aspect 63, wherein the inter-CMR downlink timing offset information indicates a downlink timing offset comprising a timing difference between a first timing associated with the first CMR and a second timing associated with the reference CMR index.

Aspect 65: The method of any of Aspects 62-64, wherein the configuration information indicates that the reference CMR index comprises a CMR index of a plurality of CMR indices that satisfies a CMR reference condition.

Aspect 66: The method of any of Aspects 59-65, wherein the CSI feedback information comprises a reporting bitmap that indicates, for each of a plurality of CMRs that includes the first CMR and the second CMR, a timing offset reporting state.

Aspect 67: The method of any of Aspects 59-66, wherein the CSI feedback information includes the inter-CMR downlink timing offset information based on a reporting condition being satisfied.

Aspect 68: The method of any of Aspects 59-67, wherein the inter-CMR downlink timing offset information comprises a quantization of the timing offset.

Aspect 69: The method of Aspect 68, wherein the quantization of the timing offset comprises at least one resolvable delay span associated with enhanced Type-II channel state information (CSI) feedback.

Aspect 70: The method of either of claim 68 or 69, wherein the quantization of the timing offset comprises at least one frequency domain basis delay unit associated with enhanced Type-II channel state information (CSI) feedback.

Aspect 71: The method of any of Aspects 59-70, further comprising transmitting a communication based on an inter-CMR downlink timing offset compensation, wherein the inter-CMR downlink timing offset compensation is based on the inter-CMR downlink timing offset information.

Aspect 72: The method of Aspect 71, wherein transmitting the communication comprises transmitting the communication via a physical downlink control channel (PDCCH) and physical downlink shared channel (PDSCH).

Aspect 73: The method of either of claim 71 or 72, wherein the inter-CMR downlink timing offset compensation comprises a per-UE cyclic shift of time domain samples associated with a post-inverse Fast Fourier Transform processing signal.

Aspect 74: The method of any of Aspects 71-73, wherein the inter-CMR downlink timing offset compensation comprises a per-UE phase ramping of frequency domain samples associated with a pre-inverse Fast Fourier Transform processing signal.

Aspect 75: An apparatus for wireless communication at a device, comprising a processor; memory coupled with the processor; and instructions stored in the memory and executable by the processor to cause the apparatus to perform the method of one or more of Aspects 1-21.

Aspect 76: A device for wireless communication, comprising a memory and one or more processors coupled to the memory, the one or more processors configured to perform the method of one or more of Aspects 1-21.

Aspect 77: An apparatus for wireless communication, comprising at least one means for performing the method of one or more of Aspects 1-21.

Aspect 78: A non-transitory computer-readable medium storing code for wireless communication, the code comprising instructions executable by a processor to perform the method of one or more of Aspects 1-21.

Aspect 79: A non-transitory computer-readable medium storing a set of instructions for wireless communication, the set of instructions comprising one or more instructions that, when executed by one or more processors of a device, cause the device to perform the method of one or more of Aspects 1-21.

Aspect 80: An apparatus for wireless communication at a device, comprising a processor; memory coupled with the processor; and instructions stored in the memory and executable by the processor to cause the apparatus to perform the method of one or more of Aspects 22-42.

Aspect 81: A device for wireless communication, comprising a memory and one or more processors coupled to the memory, the one or more processors configured to perform the method of one or more of Aspects 22-42.

Aspect 82: An apparatus for wireless communication, comprising at least one means for performing the method of one or more of Aspects 22-42.

Aspect 83: A non-transitory computer-readable medium storing code for wireless communication, the code comprising instructions executable by a processor to perform the method of one or more of Aspects 22-42.

Aspect 84: A non-transitory computer-readable medium storing a set of instructions for wireless communication, the set of instructions comprising one or more instructions that, when executed by one or more processors of a device, cause the device to perform the method of one or more of Aspects 22-42.

Aspect 85: An apparatus for wireless communication at a device, comprising a processor; memory coupled with the processor; and instructions stored in the memory and executable by the processor to cause the apparatus to perform the method of one or more of Aspects 43-58.

Aspect 86: A device for wireless communication, comprising a memory and one or more processors coupled to the memory, the one or more processors configured to perform the method of one or more of Aspects 43-58.

Aspect 87: An apparatus for wireless communication, comprising at least one means for performing the method of one or more of Aspects 43-58.

Aspect 88: A non-transitory computer-readable medium storing code for wireless communication, the code comprising instructions executable by a processor to perform the method of one or more of Aspects 43-58.

Aspect 89: A non-transitory computer-readable medium storing a set of instructions for wireless communication, the set of instructions comprising one or more instructions that, when executed by one or more processors of a device, cause the device to perform the method of one or more of Aspects 43-58.

Aspect 90: An apparatus for wireless communication at a device, comprising a processor; memory coupled with the processor; and instructions stored in the memory and executable by the processor to cause the apparatus to perform the method of one or more of Aspects 59-74.

Aspect 91: A device for wireless communication, comprising a memory and one or more processors coupled to the memory, the one or more processors configured to perform the method of one or more of Aspects 59-74.

Aspect 92: An apparatus for wireless communication, comprising at least one means for performing the method of one or more of Aspects 59-74.

Aspect 93: A non-transitory computer-readable medium storing code for wireless communication, the code comprising instructions executable by a processor to perform the method of one or more of Aspects 59-74.

Aspect 94: A non-transitory computer-readable medium storing a set of instructions for wireless communication, the set of instructions comprising one or more instructions that, when executed by one or more processors of a device, cause the device to perform the method of one or more of Aspects 59-74.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors coupled to the memory and configured to cause the UE to:
receive configuration information associated with an inter-transmission configuration indication (TCI) downlink timing offset reporting operation;
receive a first reference signal associated with a first TCI state;
receive a second reference signal associated with a second TCI state; and
transmit, based on the configuration information, inter-TCI downlink timing offset information indicating a downlink timing offset associated with at least one of the first TCI state or the second TCI state.

2. The UE of claim 1, wherein the first reference signal comprises a first periodic downlink reference signal and the second reference signal comprises a second periodic downlink reference signal.

3. The UE of claim 1, wherein at least one of the first reference signal or the second reference signal comprises at least one of a synchronization signal block or a tracking reference signal.

4. The UE of claim 1, wherein the one or more processors are further configured to cause the UE to receive at least one additional reference signal, wherein the inter-TCI downlink timing offset information indicates at least one additional downlink timing offset associated with the at least one additional reference signal.

5. The UE of claim 1, wherein the downlink timing offset comprises a timing difference measurement between a first timing associated with the first TCI state and a second timing associated with the second TCI state.

6. The UE of claim 5, wherein the first timing is based on a reference timing associated with a reference TCI state, wherein the reference TCI state is based on at least one of a reference TCI state configuration or a reference TCI state condition being satisfied by a TCI state of a plurality of activated TCI states.

7. The UE of claim 1, wherein the one or more processors, to cause the UE to transmit the inter-TCI downlink timing offset information, are configured to cause the UE to transmit a quantized downlink timing offset.

8. The UE of claim 7, wherein the quantized downlink timing offset comprises at least one of a resolvable delay span associated with enhanced Type-II channel state information (CSI) feedback or a frequency domain basis delay unit associated with enhanced Type-II channel state information (CSI) feedback.

9. The UE of claim 1, wherein the configuration information indicates a reporting periodicity associated with the inter-TCI downlink timing offset reporting operation.

10. The UE of claim 1, wherein the inter-TCI downlink timing offset reporting operation comprises an aperiodic reporting operation.

11. The UE of claim 1, wherein the configuration information indicates a trigger event for triggering the inter-TCI downlink timing offset reporting operation, and wherein the one or more processors, to cause the UE to transmit the inter-TCI downlink timing offset information, are configured to cause the UE to transmit the inter-TCI downlink timing offset information based on a detection of an occurrence of the trigger event, wherein the detection of the occurrence of the trigger event comprises a determination that the downlink timing offset satisfies a reporting condition.

12. The UE of claim 1, wherein the one or more processors are further configured to cause the UE to receive at least one channel state information (CSI) reference signal (CSI-RS) based on an inter-TCI downlink timing offset compensation, wherein the inter-TCI downlink timing offset compensation is based on the inter-TCI downlink timing offset information.

13. The UE of claim 1, wherein the one or more processors are further configured to cause the UE to receive at least one of a physical downlink control channel (PDCCH) communication or a physical downlink shared channel (PDSCH) communication based on an inter-TCI downlink timing offset compensation, wherein the inter-TCI downlink timing offset compensation is based on the inter-TCI downlink timing offset information.

14. The UE of claim 13, wherein the inter-TCI downlink timing offset compensation comprises a per-UE cyclic shift of time domain samples associated with a post-inverse Fast Fourier Transform processing signal.

15. The UE of claim 13, wherein the inter-TCI downlink timing offset compensation comprises a per-UE phase ramping of frequency domain samples associated with a pre-inverse Fast Fourier Transform processing signal.

16. A network node for wireless communication, comprising:
a memory; and
one or more processors coupled to the memory and configured to cause the network node to:
transmit configuration information associated with an inter-transmission configuration indication (TCI) downlink timing offset reporting operation;
transmit a first reference signal associated with a first TCI state;
transmit a second reference signal associated with a second TCI state; and
receive, based on the configuration information, inter-TCI downlink timing offset information indicating a downlink timing offset associated with at least one of the first TCI state or the second TCI state.

17. The network node of claim 16, wherein the downlink timing offset comprises a timing difference measurement between a first timing associated with the first TCI state and a second timing associated with the second TCI state.

18. A user equipment (UE) for wireless communication, comprising:
a memory; and
one or more processors coupled to the memory and configured to cause the UE to:
receive configuration information associated with a multiple transmission reception point (mTRP) coherent joint transmission (CJT) channel state information (CSI) reporting operation, the configuration information indicating an inter-CSI-RS for CSI measurement (inter-CMR) downlink timing offset reporting operation;
receive a first CMR associated with a first transmission reception point (TRP);
receive a second CMR associated with a second TRP; and
transmit, based on the configuration information, CSI feedback information that includes inter-CMR downlink timing offset information indicating a timing offset associated with at least one of the first CMR or the second CMR.

19. The UE of claim 18, wherein the timing offset comprises a timing difference measurement between a first timing associated with the first CMR and a second timing associated with the second CMR.

20. The UE of claim 19, wherein the first timing is based on a reference timing associated with a reference CMR index, wherein the reference CMR index is based on at least one of a reference CMR index configuration or a reference CMR state condition being satisfied by a CMR index of a plurality of CMR indices.

21.-29. (canceled)
